(19) United States
(12) Patent Application Publication
(10) Pub. No.: US 2025/0193830 A1
(43) Pub. Date: Jun. 12, 2025

(54) METHOD FOR WIRELESS COMMUNICATION, AND ELECTRONIC DEVICE AND COMPUTER-READABLE STORAGE MEDIUM

(71) Applicant: Sony Group Corporation, Tokyo (JP)

(72) Inventors: Ke MA, Beijing (CN); Haoming ZOU, Beijing (CN); Zhaocheng WANG, Beijing (CN); Jianfei CAO, Beijing (CN)

(73) Assignee: Sony Group Corporation, Tokyo (JP)

(21) Appl. No.: 18/846,291

(22) PCT Filed: Mar. 22, 2023
(86) PCT No.: PCT/CN2023/082993

§ 371 Date: Sep. 12, 2024

(30) Foreign Application Priority Data
Mar. 29, 2022 (CN) 202210318983.8

(51) Int. Cl. H04W 64/00; H04L 5/00

(52) U.S. Cl. CPC H04W 64/00; H04L 5/0048

(57) ABSTRACT

Provided are a method for wireless communication, and an electronic device and a computer-readable storage medium. The electronic device may comprise a processing circuit which is configured to: obtain a plurality of pieces of positioning information of a user equipment, which are respectively related to each base station in a plurality of base stations, wherein the positioning information, which is related to each base station, of the user equipment is acquired on the basis of a reception signal of a reference signal which is transmitted between the base station and the user equipment, and is acquired by using a positioning model related to the base station, and the plurality of pieces of positioning information of the user equipment have the same form as each other; and on the basis of the plurality of pieces of positioning information of the user equipment, obtain a positioning result of the user equipment.

This application claims priority to a Chinese patent application filed with the China Patent Office on Mar. 29, 2022, with application No. 202210318983.8 and invention name “METHOD FOR WIRELESS COMMUNICATION, AND ELECTRONIC DEVICE AND COMPUTER-READABLE STORAGE MEDIUM”, the entire contents of which are incorporated by reference into this application.

### TECHNICAL FIELD

The present application relates to the technical field of wireless communication, and more specifically, to a method for wireless communication, an electronic device and a computer-readable storage medium that facilitate positioning of user equipment.

### BACKGROUND

High-precision positioning is one of the important requirements for the next generation of wireless communications and has broad application prospects in the fields of the Internet of Things and vehicle networks. Support for high-precision positioning has also received widespread attention in communication standards. In the fifth generation mobile networks (5G) Rel. 16 of the Third Generation Partnership Project (3GPP), for the downlink positioning reference signal, the positioning reference signal (PRS) is used, and for the uplink positioning reference signal, the SRS configured in the positioning sounding reference signal (SRS) resource set (SRS-PosResourceSet) is used.

Traditional positioning methods mainly include two types. The first type is a positioning method based on the global satellite navigation system, which uses the time of flight (ToF) between the user equipment and multiple satellites for positioning. This method has been widely used, but its positioning accuracy is low and its power consumption is high. The second type is triangulation positioning based on geometric properties, which uses the ToF, Angle of Arrival (AoA), Angle of Departure (AoD) and other features between the base station and the user equipment to calculate the UE position. FIG. 1 is a schematic diagram for illustrating triangulation positioning based on AoD, which schematically shows that the positioning result of the UE can be obtained based only on the current serving base station TRP1 of the user equipment UE and one neighboring base station TPR2. However, this technology is highly dependent on the Line of Sight (LOS) scenario, and its performance deteriorates significantly in the Non-Line of Sight (NLOS) scenario.

### SUMMARY

The following presents a simplified summary of the disclosure in order to provide a basic understanding of some aspects of the disclosure. However, it should be understood that this summary is not an exhaustive overview of the disclosure. It is not intended to identify a key or important part of the present disclosure, nor is it intended to limit the scope of the present disclosure. Its sole purpose is to present some concepts about the disclosure in a simplified form as a prelude to the more detailed description that is presented later.

An object of at least one aspect of the present disclosure is to provide an electronic device and a method for wireless communication, and a computer-readable storage medium, which are conducive to achieving higher-precision positioning of user equipment in various scenarios.

According to a first aspect of the present disclosure, an electronic device is provided, comprising a processing circuit, wherein the processing circuit is configured to: obtain a plurality of pieces of positioning information of a user equipment respectively related to each of a plurality of base stations, wherein the positioning information of the user equipment related to each base station is obtained based on a received signal of a reference signal transmitted between the base station and the user equipment and using a positioning model related to the base station, and wherein the plurality of pieces of positioning information of the user equipment have the same form as each other; and obtain a positioning result of the user equipment, based on the plurality of pieces of positioning information of the user equipment.

According to a second aspect of the present disclosure, an electronic device is provided, which includes a processing circuit, which is configured to: obtain, based on a received signal of a reference signal transmitted between a subject base station and user equipment and using a positioning model related to the subject base station, positioning information of the user equipment related to the subject base station; and provide the positioning information of the user equipment related to the subject base station to another electronic device, so that said another electronic device can obtain a positioning result of the user equipment based on a plurality of pieces of positioning information of the user equipment respectively related to a plurality of base stations including the subject base station, wherein the plurality of pieces of positioning information of the user equipment have the same form as each other.

According to a third aspect of the present disclosure, an electronic device is provided, which includes a processing circuit, and the processing circuit is configured to: send or receive a reference signal to or from each of a plurality of base stations, so that each of the plurality of base stations can obtain positioning information of the electronic device related to the base station based on the received signal of the reference signal transmitted between the base station and the electronic device and using a positioning model related to the base station, wherein the positioning information of the electronic device related to each of the plurality of base stations has the same form.

According to the first aspect of the present disclosure, a method for wireless communication is also provided, the method comprising: obtaining a plurality of pieces of positioning information of a user equipment respectively related to each of a plurality of base stations, wherein the positioning information of the user equipment related to each base station is obtained based on a received signal of a reference signal transmitted between the base station and the user equipment and using a positioning model related to the base station, and wherein the plurality of pieces of positioning information of the user equipment have the same form as each other; and obtaining a positioning result of the user equipment, based on the plurality of pieces of positioning information of the user equipment.

According to the second aspect of the present disclosure, a method for wireless communication is also provided, the method comprising: obtaining, based on a received signal of a reference signal transmitted between a subject base station and user equipment and using a positioning model related to the subject base station, positioning information of the user equipment related to the subject base station; and providing the positioning information of the user equipment related to the subject base station to another electronic device, so that said another electronic device can obtain a positioning result of the user equipment based on a plurality of pieces of positioning information of the user equipment respectively related to a plurality of base stations including the subject base station, wherein the plurality of pieces of positioning information of the user equipment have the same form as each other.

According to the third aspect of the present disclosure, a method for wireless communication is also provided, the method comprising: controlling an electronic device to send or receive a reference signal to or from each of a plurality of base stations, so that each of the plurality of base stations can obtain positioning information of the electronic device related to the base station based on the received signal of the reference signal transmitted between the base station and the electronic device and using a positioning model related to the base station, wherein the positioning information of the electronic device related to each of the plurality of base stations has the same form.

According to another aspect of the present disclosure, a non-transitory computer-readable storage medium storing executable instructions is also provided. When the executable instructions are executed by a processor, the processor executes the above-mentioned method for wireless communication or various functions of the above-mentioned electronic device.

According to other aspects of the present disclosure, a computer program code and a computer program product for implementing the above method according to the present disclosure are also provided.

According to at least one aspect of an embodiment of the present disclosure, a positioning model associated with each base station (for example, a positioning model obtained through deep learning and capable of reflecting the characteristics of the wireless environment/wireless channel around the base station) is used to extract positioning information of a user device, and a positioning result of the user device is obtained based on a plurality of pieces of positioning information extracted using multiple positioning models respectively associated with multiple base stations, thereby utilizing the positioning information extracted by each positioning model in a fusion manner, which is beneficial for providing higher-precision positioning results for the user device in various scenarios.

Other aspects of the embodiments of the present disclosure are given in the following description, wherein the detailed description is used to fully disclose the preferred embodiments of the embodiments of the present disclosure without imposing limitations thereon.

### BRIEF DESCRIPTION OF THE DRAWINGS

The drawings described herein are for illustrative purposes only of selected embodiments and not all possible implementations, and are not intended to limit the scope of the present disclosure. In the drawings:

FIG. 1 is a schematic diagram for illustrating triangulation positioning based on AoD;

FIG. 2 is a schematic diagram for illustrating that different base stations have different wireless environments;

FIG. 3 is a block diagram showing a configuration example of an electronic device according to an embodiment of the present disclosure;

FIGS. 4A and 4B are schematic diagrams for explaining usage examples of a positioning model according to an embodiment of the present disclosure;

FIG. 5 is a schematic diagram for illustrating an example of a convolutional neural network (CNN) model;

FIG. 6 is a flowchart for illustrating an example signaling interaction of a positioning process according to an embodiment of the present disclosure;

FIG. 7 is a schematic diagram for illustrating an example of determining a positioning base station group;

FIG. 8 is a schematic diagram showing distribution curves with different kurtosis;

FIG. 9 is a flowchart for illustrating an example signaling interaction of a process for determining a positioning base station group according to an embodiment of the present disclosure;

FIG. 10 is a schematic diagram of candidate base stations that may be used for positioning in a simulation example of a positioning process according to an embodiment of the present disclosure;

FIG. 11 is a schematic diagram for illustrating the results of a simulation example of a positioning process according to an embodiment of the present disclosure;

FIG. 12 is a flowchart showing a process example of a method for wireless communication according to a first embodiment of the present disclosure;

FIG. 13 is a flowchart showing a process example of a method for wireless communication according to a second embodiment of the present disclosure;

FIG. 14 is a flowchart showing a process example of a method for wireless communication according to a third embodiment of the present disclosure;

FIG. 15 is a block diagram showing a first example of a schematic configuration of a server to which the technology of the present disclosure can be applied;

FIG. 16 is a block diagram showing a first example of a schematic configuration of an eNB to which the technology of the present disclosure may be applied;

FIG. 17 is a block diagram showing a second example of a schematic configuration of an eNB to which the technology of the present disclosure may be applied;

FIG. 18 is a block diagram showing an example of a schematic configuration of a smartphone to which the technology of the present disclosure may be applied;

FIG. 19 is a block diagram showing an example of a schematic configuration of a car navigation device to which the technology of the present disclosure may be applied.

While the disclosure is susceptible to various modifications and alternative forms, specific embodiments thereof have been shown by way of example in the drawings and are herein described in detail. It should be understood, however, that the description of specific embodiments herein is not intended to limit the disclosure to the particular forms disclosed, but on the contrary, the disclosure is intended to cover all modifications, equivalents, and alternatives falling within the spirit and scope of the disclosure. It should be noted that corresponding reference numerals indicate corresponding parts throughout the figures of the drawings.

### DETAILED DESCRIPTION OF EMBODIMENTS

Examples of the present disclosure will now be described more fully with reference to the accompanying drawings.

The following description is merely exemplary in nature and is not intended to limit the present disclosure, application, or uses. Example embodiments are provided so that this disclosure will be thorough, and will fully convey the scope to those skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known structures, and well-known technologies are not described in detail.

The description will be in the following order:
1. Overview
2. Configuration Example of Electronic Device of First Embodiment
   2.1 First Configuration Example
      2.1.1 First use case of positioning model
      2.1.2 Second use case of positioning model
      2.1.3 Example signaling interaction during positioning process
      2.1.4 Example of determining a positioning base station group
      2.1.5 Modification Example
   2.2 Second Configuration Example
   2.3 Third Configuration Example
3. Configuration Example of Electronic Device of Second Embodiment
4. Configuration Example of Electronic Device of Third Embodiment
5. Simulation results
6. Method Embodiment
7. Application Examples

### 1. Overview

In order to solve the problems existing in the two types of traditional positioning methods, some studies have proposed a third type of positioning method, namely fingerprint positioning. Fingerprint positioning uses the specificity of the wireless environment to record and store the wireless channel characteristics of the reference positions as a fingerprint dataset. When user equipment needs to be positioned, the wireless channel characteristics corresponding to the user equipment are measured, and the most similar reference position is selected from the fingerprint data set as the positioning result. Fingerprint positioning can be applied to NLOS scenarios and may provide higher positioning accuracy. However, the premise for achieving this goal is to store a large-capacity fingerprint data set, which will bring great overhead.

In order to solve the problems of traditional fingerprint positioning, it is proposed to apply deep learning to positioning, so as to utilize its powerful adaptive fitting ability to fully extract complex high-dimensional environmental features and thus reduce positioning errors. The deep learning-based positioning solution does not need to store data sets, but only needs to store trained positioning models, which helps reduce storage overhead. In addition, the online learning strategy of deep learning also supports rapid model adjustment according to changes in the wireless environment.

In particular, the inventors proposes using multiple positioning models respectively associated with multiple base stations (for example, a positioning model obtained through deep learning that can reflect the characteristics of the wireless environment/wireless channel around the base station) to extract the positioning information (positioning features) of the user equipment from the received signal of the reference signal transmitted between the base station and the user equipment, and then fusing the extracted positioning information to obtain the positioning result of the user equipment. FIG. 2 is a schematic diagram for illustrating that different base stations have different wireless environments, wherein (A) and (B) respectively show the wireless environments of base station TRP1 and base station TRP2. Since each base station has its own specific wireless environment, there is a unique correlation between the received signal of the reference signal transmitted between the base station and the user equipment and the position of the user equipment. According to the inventive concept of the inventors, the correlation between the wireless environments of multiple base stations and the user positions can be used to obtain a plurality of pieces of positioning information of the user equipment, and then the positioning result of the user equipment can be obtained based on the positioning information. In this way, it is possible to avoid a decrease in positioning accuracy caused by inaccurate positioning information extracted using a positioning model related to a single base station, and it is beneficial to provide higher-precision positioning results for user equipment in various scenarios.

### 2. Configuration Example of Electronic Device of First Embodiment

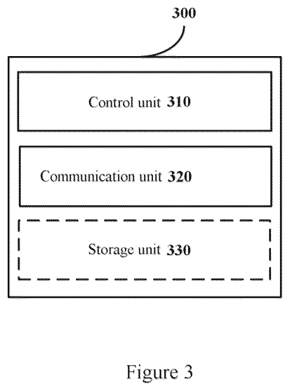

FIG. 3 is a block diagram showing a configuration example of an electronic device according to an embodiment of the present disclosure.

As shown in FIG. 3, the electronic device 300 may include a control unit 310, a communication unit 320, and an optional storage unit 330.

Here, each unit of the electronic device 300 may be included in a processing circuit. It should be noted that the electronic device 300 may include one processing circuit or multiple processing circuits. Further, the processing circuit may include various discrete functional units to perform various different functions and/or operations. It should be noted that these functional units may be physical entities or logical entities, and units with different names may be implemented by the same physical entity.

The electronic device 300 of the first embodiment may be a core network side device, or a base station side device, or a terminal side device, and the present disclosure does not limit this. Further details of the example processing will be described later in the first, second and third configuration examples, respectively, in conjunction with the cases where the electronic device 300 is respectively implemented on the core network side, the base station side and the terminal side.

According to the first embodiment, the control unit 310 of the electronic device 300 can (for example, using the communication unit 320) obtain a plurality of pieces of positioning information of the user equipment respectively related to each base station in the multiple base stations, wherein the positioning information of the user equipment related to each base station is obtained based on the received signal of the reference signal transmitted between the base station and the user equipment and using the positioning model related to the base station, wherein the plurality of pieces of positioning information of the user equipment have the same form as each other. In addition, the control unit 310 may also obtain a positioning result of the user equipment based on the plurality of pieces of positioning information of the user equipment.

Here, the positioning model associated with each base station may be, for example, a positioning model obtained through deep learning and capable of reflecting the characteristics of the wireless environment or wireless channel around the base station. As an example, a positioning model based on a convolutional neural network (CNN) such as that described in detail later may be employed.

In addition, the input of the positioning model related to each base station may be a received signal of an uplink reference signal received by the base station from the user equipment, or may be a received signal of a downlink reference signal received by the user equipment from the base station. As an example only and not a limitation, the received signal of the reference signal input into the positioning model may be in the form of a signal quality of the received signal of the reference signal, such as a reference signal received power (RSRP) or a signal to interference plus noise ratio (SINR) of the received signal.

In addition, respective positioning models related to a plurality of base stations may be arranged in a distributed manner, that is, directly arranged in the corresponding base stations. In this case, each base station can extract the positioning information by itself and send it to the electronic device 300. Alternatively, respective positioning models associated with a plurality of base stations may also be arranged in a centralized manner, for example, in the electronic device 300. In this case, the electronic device 300 may, for example, obtain received signals of uplink or downlink reference signals from multiple base stations or the user equipment, and then extract positioning information using various positioning models arranged by itself. The present disclosure has no particular limitation on the reference signal used by the positioning model and the arrangement of the positioning model. Hereinafter, further detailed descriptions will be given to various preferred configurations.

In the context of the present disclosure, a set of multiple base stations whose positioning models are used to extract positioning information of user equipment may be collectively referred to as a positioning base station group, and a base station in the positioning base station group may be referred to as a positioning base station. In an embodiment of the present disclosure, for a user equipment, a plurality of pieces of positioning information, which are respectively related to the wireless environment/wireless channel characteristics of each of multiple base station in a positioning base station group and extracted by using multiple positioning models of the multiple base stations are used, rather than a single positioning information, which is related to the wireless environment/wireless channel characteristics of a single base station (such as the current serving base station) and extracted by using the positioning model of a single base station. This is beneficial to comprehensively consider the wireless environment/wireless channel characteristics of multiple base stations, thereby providing more accurate positioning results. In addition, since the plurality of pieces of positioning information of a given user equipment extracted using various positioning models have the same form, these positioning information can be processed uniformly during calculation without distinguishing their sources, which is conducive to simplifying the processing.

As an example, the positioning base station group can be a collection of base stations that meet predetermined conditions, such as that the received signal of the signal transmitted between the base station and the user equipment is less interfered by noise and/or that the channel between the base station and the user equipment is more likely to be a line of sight, so that the positioning information extracted using the received signal of the reference signal transmitted between such a base station and the user equipment is more reliable.

For example, the predetermined conditions set to ensure that the received signal is less affected by noise interference may include that the estimated distance between the candidate base station and the serving base station of the user equipment is less than a (first) predetermined threshold and/or the estimated distance between the candidate base station and the user equipment is less than a (second) predetermined threshold. The two predetermined thresholds may be the same or different and may be set appropriately. The predetermined condition may also include that the channel quality between (the candidate base station) and the user equipment is better than a predetermined threshold. The channel quality may be represented by, for example, the quality of a received signal, such as RSRP or a path loss of a channel. In addition, the predetermined condition set to ensure that the channel has a high probability of being a line of sight path may include that the channel kurtosis of the angle domain channel or the delay domain channel between the candidate base station and the user equipment is greater than a predetermined threshold. One or more of the above conditions may be applied to determine a positioning base station group for a given user equipment.

Further details of the process by which the electronic device 300 determines the positioning base station group via an appropriate manner will be described in detail later. In a simplified example, the electronic device 300 can, for example, utilize various existing methods to obtain (from related devices or by itself) the estimated distance between each base station and the serving base station/user equipment, and then determine the base station that meets the predetermined conditions regarding the distances to determine the positioning base station group.

The exemplary processing of the electronic device and its constituent units according to the first embodiment has been described above. Next, further configuration examples or example processing according to the first embodiment of the present disclosure will be described with respect to the cases where the electronic device of the first embodiment is respectively implemented on the core network side, the base station side, and the terminal side.

### 2.1 First Configuration Example

In the first configuration example, the electronic device 300 is a core network side device. In this example, preferably, the positioning models related to respective base stations in the positioning base station group are arranged in a distributed manner, that is, they are directly arranged in the corresponding base stations, and each base station in the positioning base station group can extract the positioning information by itself and send it to the electronic device 300. Since the computing power of base stations is generally stronger than that of user equipment, distributing the positioning model in each base station is beneficial to reducing computing delay.

Accordingly, as a way for the electronic device 300 to obtain the positioning information of the user equipment, the control unit 310 of the electronic device 300 may be configured to control the communication unit 320 to receive the positioning information of the user equipment related to each base station from multiple base stations respectively. In this example, preferably, the reference signal used for positioning is an uplink reference signal. That is, the input of the positioning model related to each base station may be a received signal of an uplink reference signal received by the base station from the user equipment, thereby avoiding feedback overhead from the user equipment to the base station and being helpful in simplifying the signaling process. As an example, for the uplink reference signal, the SRS resources in the positioning SRS resource set (SRS-PosResourceSet) may be used. Next, example processing in this example will be described.

### 2.1.1 First Usage Example of Positioning Model

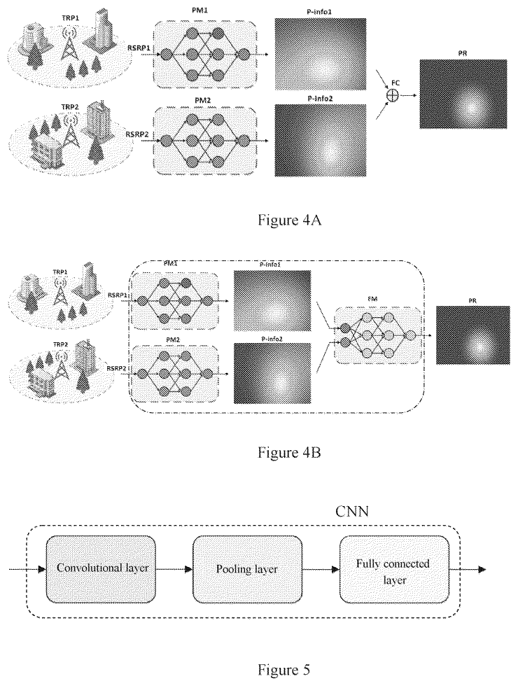

FIG. 4A is a schematic diagram for explaining a first usage example of a positioning model according to an embodiment of the present disclosure. As shown in FIG. 4A, in this usage example, the positioning model PMi related to each base station TRPi (hereinafter also appropriately referred to as the positioning model of each base station) is used to extract positioning information (or positioning features) P-infoi from the received signal of the reference signal transmitted between the base station and a given user equipment, such as the RSRPi of the reference signal; thereafter, the electronic device 300 obtains this positioning information from each base station TRPi, and then obtains the final positioning result PR through appropriate fusion calculation FC, where i=1, . . . , N, and N represents the number of base stations in the positioning base station group. In this example, for the convenience of illustration and description, a simplified case of N=2 is set, but the embodiments of the present disclosure are not limited thereto, but can be extended to a case where the positioning base station group includes more base stations. In addition, in this example, the positioning model PMi may be arranged at the base station TRPi, and the reference signal may be an uplink reference signal such as an SRS resource in a positioning SRS resource set, but the embodiments of the present disclosure are not limited thereto.

As an example, the positioning model PMi of each base station TRPi may be a CNN-based model. Since wireless channels, such as angle domain or delay domain channels, have the characteristics of prominent local content, the CNN-based positioning model will be conducive to extracting the wireless channel characteristics of the base station, that is, it will be conducive to extracting channel characteristics from the received signal of the reference signal, such as the RSRPPi of the reference signal, and then obtaining the positioning information P-infoi.

FIG. 5 is a schematic diagram for explaining an example of a CNN model. As an example, the positioning model PMi of each base station can be a CNN model such as that shown in FIG. 5, which includes a convolutional layer, a pooling layer, and a fully connected layer arranged sequentially from the input side to the output side. The input of the CNN model serving as the positioning model PMi can be, for example, the received signal of the uplink reference signal of the base station TRPi, such as RSRPᵢ∈ [symbol] ^{N}^{_{BS}}^{×N}^{_{UE}} of the uplink reference signal, where N_{BS} and N_{UE} are the numbers of candidate beams at the base station TRPi and the user equipment UE, respectively. That is, in this example, the base station TRPi uses its N_{BS} receiving beams to try to receive the N_{UE} transmitting beams of the user equipment UE. The convolution layer of the CNN model uses multiple layers of convolution blocks to extract the features of the received signal of the input reference signal (such as the RSRPᵢ of the reference signal), where each layer of convolution blocks includes a convolution layer and a ReLU activation layer. The ReLU activation layer can be expressed as mathematical formula (1):

$$Re LU ( x ) = \{ \begin{matrix}0 , & x < 0 \\ x , & x \geq 0\end{matrix} \qquad ( 1 )$$

The pooling layer of the CNN model as the positioning model PMi downsamples the features extracted by the convolutional layer and provides them to the fully connected layer. The fully connected layer transforms the features downsampled by the pooling layer into the form (size) of the specified positioning information. Here, assuming that the output of the pooling layer, i.e., the input of the fully connected layer, is xᵢ, the output of the fully connected layer yᵢ can be expressed as, for example, mathematical formula (2):

$${y}_{i} = {W}_{i} {x}_{i} + {b}_{i} \qquad ( 2 )$$

Among them, Wᵢ and bᵢ are the linear weights and biases of the fully connected layer respectively. The output yᵢ of the fully connected layer of the CNN model of the positioning model PMi is the positioning information P-infoi of the user equipment extracted using the positioning model PMi.

The positioning information extracted by the positioning model of each base station, such as the above-mentioned CNN form, may include hard information (the position of the user equipment) and various forms of soft information (confidence, probability distribution, etc.). As an example, the form of positioning information may include at least one of the following: the position of the user equipment; the position of the user equipment and confidence; and the probability distribution of the position of the user equipment.

Accordingly, the electronic device 300 can utilize the control unit 310 to perform fusion calculation in an appropriate manner based on a plurality of pieces of positioning information of the user equipment obtained from multiple base stations to obtain a positioning result of the user equipment. For example, when the positioning information is in the form of the position of the user equipment, the electronic device can obtain the final positioning result by averaging respective pieces of positioning information. When the positioning information is in the form of the position of the user equipment and confidence, the electronic device can obtain the final positioning result by taking the confidence as the weight and performing weighted averaging on each piece of positioning information. When the positioning information is in the form of probability distribution of the position of the user equipment, the electronic device can obtain the final positioning result by multiplying the respective probability distributions to obtain the position with the highest probability.

The various parameters of a positioning model, such as in the form of the above-mentioned CNN model, can be obtained through training. In this example, the positioning model PMi of each base station TRPi may be obtained in advance through training using received signals of reference signals transmitted between the base station and one or more user equipments with known positions as training data. Ideally, the set of the positions of the one or more user equipments used for training covers the entire environment range of the base stations TRPi (e.g., the entire range in which the user equipments may communicate with the base stations TRPi). In other words, in this example, the positioning model of each base station in the positioning base station group can be obtained by separate training. For example, for the positioning model PMi of the base station TRPi, a loss function can be constructed based on the difference between the positioning information yᵢ extracted for the user equipment and the actual position information of the user equipment. For example, the loss function can be optimized using an Adaptive Moment Estimation (Adam) optimizer of the gradient back-propagation algorithm. For example, the training is completed when the loss function is minimized (or other iteration stop conditions are met), and the preferred parameters of the positioning model PMi are obtained.

### 2.1.2 Second Usage Example of Positioning Model

FIG. 4B is a schematic diagram for explaining a second usage example of the positioning model according to an embodiment of the present disclosure. The main difference between the second usage example shown in FIG. 4B and the first usage example shown in FIG. 4A is that the electronic device 300 can obtain the final positioning result PR based on the positioning information P-infoi of the user equipment extracted by each positioning model PMi, using the fusion model FM (rather than the fusion calculation FC described in reference to FIG. 4A). Similar to the example of FIG. 4A, in this example, the positioning model PMi may be arranged at the base station TRPi, and the reference signal may be an uplink reference signal such as an SRS resource in a positioning SRS resource set, but the embodiments of the present disclosure are not limited thereto.

In the second usage example shown in FIG. 4B, the positioning model PMi of each base station may also be a CNN model such as that shown in FIG. 5. In this case, the input of the CNN model of the positioning model PMi can be, for example, the received signal of the uplink reference signal of the base station TRPi, such as RSRPᵢ∈ [symbol] ^{N}^{_{BS}}^{×N}^{_{UE}} of the uplink reference signal and its output can be the output yᵢ of the fully connected layer, which is the positioning information P-infoi and has the specified form or size of the positioning information P-infoi.

In the second usage example, the positioning information output by the CNN model serving as the positioning model PMi can have the same form as that of the first usage example (for example, but not limited to, the position of the user device; the position of the user device and confidence; the probability distribution of the position of the user device) or a different form therefrom. In this example, the positioning information extracted by the positioning model of each base station is directly input into another model, namely the fusion model. Therefore, the positioning information is not required to have a specified form suitable for simple fusion calculation (such as the form of the first usage example). Instead, the positioning information can be regarded as the output of an intermediate layer of an overall model that includes various positioning models and fusion models (as shown in the dotted rectangular box in FIG. 4B). The positioning information can be in any form or size that is conducive to the overall model to obtain accurate positioning results.

The fusion model can be various appropriate models obtained through deep learning. As an example, the fusion model may include a CNN-based model. Considering that the number of base stations in the positioning base station group may change dynamically, the input dimension of the fusion model may also change dynamically. Therefore, it is particularly advantageous to use a CNN that can handle inputs of dynamic sizes as the fusion model.

Similar to the positioning model, the fusion model can also adopt a CNN model such as that shown in FIG. 5, which includes a convolutional layer, a pooling layer, and a fully connected layer arranged sequentially from the input side to the output side. The input of the fusion model is the positioning information Y_{info}=[P-info1, . . . , P-infoN] extracted by the positioning models PM1, . . . , PMN of each base station in the positioning base station group. The convolution layer of the fusion model can use multi-layer convolution blocks to extract the features of the positioning information Y_{info}, the pooling layer can downsample the features extracted by the convolution layer, and the fully connected layer can transform the downsampled features of the pooling layer into the size of the positioning result to output the positioning result PR of a specified size. As an example, the positioning result PR may have a similar form to the positioning information in the first usage example, such as the position of the user equipment; the position of the user equipment and confidence; and the probability distribution of the position of the user equipment.

The various parameters of the positioning models and the fusion model, such as in the form of the above-mentioned CNN model, can be obtained through training. In this example, the positioning model PMi of each base station TRPi among the multiple base stations and the fusion model FM utilized by the electronic device 300 can be pre-obtained through joint training using the received signal of the reference signal transmitted between each base station and one or more user devices with known positions as training data.

In other words, in this example, since multiple positioning models and the fusion model are used as an overall model, their training is also performed as that for an overall model. For example, the electronic device 300 may construct a loss function for the difference between the positioning result output by the fusion model FM and the actual position of the user equipment, for example, by using the control unit 310. For example, the positioning result PR output by the fusion model FM can be simply pₚᵣₑ=(xₚᵣₑ, yₚᵣₑ), where xₚᵣₑ, yₚᵣₑ are the position coordinates respectively. In this case, the mean square error (MSE) loss can be used to construct the loss function E based on the positioning result pₚᵣₑ and the true position p=(x, y), which is expressed as mathematical formula (3):

$$E = {\vert p - {p}_{pre} \vert}^{2} = {( x - {x}_{pre} )}^{2} + {( y - {y}_{pre} )}^{2} \qquad ( 3 )$$

Based on the above loss function, the Adam optimizer in the gradient back-propagation algorithm can be used for optimization, and the training is completed when the loss function is minimized (or other iteration stop conditions are met), and the optimal parameters of multiple positioning models and the fusion model are obtained.

In the above-mentioned training process, when each positioning model is respectively arranged at a corresponding base station, the electronic device 300, for example, uses the control unit 310 to control the communication unit 320 to communicate with the corresponding base station where each positioning model is arranged, so as to feed back to each base station the gradient of its positioning model, thereby realizing the joint training of each positioning model and the fusion model.

### 2.1.3 Example Signaling Interaction During Positioning Process

Next, the example signaling interaction of the positioning process according to the embodiment of the present disclosure will be described with reference to specific examples, which can be implemented, for example, by utilizing the interaction between the electronic device 300 (an electronic device implemented on the core network side) of the first configuration example of the above-mentioned first embodiment and related devices.

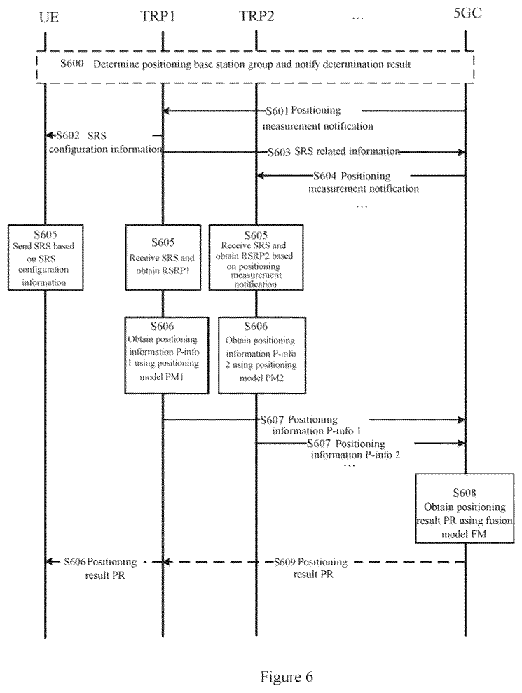

FIG. 6 is a flowchart for illustrating an example signaling interaction of a positioning process according to an embodiment of the present disclosure. In the example of FIG. 6, the electronic device 300 of the first configuration example is implemented as a core network device 5GC, the user equipment to be positioned is the UE, and the positioning base station group determined for the UE includes the current serving base station TRP1 of the user equipment UE and another base station TRP2, etc. For ease of description, other base stations in the positioning base station group are omitted from illustration, but it can be understood that the example process can be similarly applied to the case where the positioning base station group includes more base stations. In this example, for example, the multiple positioning models PM1, PM2, etc. and the fusion model FM obtained through joint training described in the second usage example of FIG. 4B above are respectively arranged in the corresponding base stations TRP1, TRP2, etc. and the core network device 5GCC.

As shown in FIG. 6, optionally, first, in step S600, the core network device 5GC determines the base stations TRP1, TRP2, etc. that meet the predetermined conditions as the positioning base station group through appropriate processing (and optionally signaling interaction with related devices), and notifies each base station in the positioning base station group of the determination result. As an example, the core network device 5GC may simply determine each base station within a threshold distance from the UE's current serving base station TRP1 as a positioning base station group. The determination result notification sent by 5GC to the current serving base station TRP1 of the UE may include, for example, the identification (ID) of each base station in the positioning base station group and optional relevant information of each base station such as position information. The determination result notification sent by 5GC to other base stations in the positioning base station group, such as TRP2, is optional, and may, for example, only include indication information that the base station is included in the positioning base station group. Further details of determining the positioning base station group will be described later.

Then, for example, in step S601, 5GC sends a positioning measurement notification to the UE's current serving base station TRP1.

In step S602, the UE's current serving base station TRP1 sends SRS configuration information to the UE based on the received positioning measurement notification (and optionally, based on the determination result notification received in step S600), for example via radio resource control (RRC) signaling, so as to configure, for the UE, SRS resources that can be used for positioning measurement by each base station in the positioned base station group. TRP1 can configure, for example, an existing periodic, semi-periodic or aperiodic SRS signal for the UE, and preferably configures a periodic SRS signal to simplify the process. Preferably, TRP1 can configure an SRS signal in a positioning SRS resource set for the UE.

In a preferred example, TRP1 can configure the UE to periodically send omnidirectional beams or all directional beams, for example, to send 64 or 8 beams covering the entire beam range in sequence. For this configuration, each base station in the positioning base station group can receive all beams sent by the UE in parallel with each other. Alternatively, if TRP1 can understand the positions of each base station in the positioning base station group based on the positioning measurement notification received in step S602 (and optionally based on the determination result notification received in step S600), TRP1 can configure the UE to, for example, send a directional beam to each base station in turn. For this configuration, each base station in the positioning base station group can receive the corresponding beam sent by the UE in turn.

In addition, in step S603, TRP1 also sends information related to the configured SRS signal to 5GC. The SRS related information may include, for example, the time-frequency resources of the SRS to be sent by the UE and optional beam information. Then, in step S604, 5GC can send a positioning measurement notification to other base stations in the positioning base station group, such as TRP2, based on the received SRS related information, to notify the base station of the time and frequency resources and optional beam information used for the SRS signal to be sent by UE.

Next, in step S605, the UE sends an SRS signal using designated time-frequency resources (and optionally designated beams) based on the SRS configuration information received from TRP1; the current serving base station TRP1 in the positioning base station group correspondingly receives the SRS signal sent by the UE and obtains its received signal, such as its RSRP1; other base stations in the positioning base station group, such as TRP2, also receive the SRS signal sent by the UE based on the positioning measurement notification and obtain their received signals, such as the RSRP2. As mentioned above, depending on the specific configuration of the SRS signal for the UE by the UE's current serving base station TRP1 (the SRS signal sent through an omnidirectional beam, or the SRS signal sent through a directional beam for each positioning base station), each base station in the positioning base station group can receive all beams sent by the UE in parallel, or receive the corresponding beam sent by the UE in sequence, and the present disclosure does not limit this.

Next, in step S606, each positioning base station extracts the positioning information of the UE using its own positioning model based on the received signal of the SRS signal. In step S607, each positioning base station sends the extracted positioning information to 5GC. In step S608, 5GC uses its fusion model to obtain the positioning result PR. In optional step S609, 5GC sends the positioning result PR to the UE via the current serving base station TRP1.

In one example, the 5GC may have a position management function (LMF) and an optional access and mobility management function (AMF). In this case, various signaling interactions related to positioning can be performed between the LMF function in the 5GC and the various base stations TRP1, TRP2, etc. in the positioning base station group of the next generation radio access network (NG-RAN) (for example, via the AMF function) through the NR (New Radio) Positioning Protocol Annex (NRPPa) signaling.

In the above step S602, as an example, it is described that the current serving base station TRP1 of the UE configures the SRS signal in the existing positioning SRS resource set for the UE and sends the SRS configuration information to the UE accordingly. Optionally, according to an embodiment of the present disclosure, the current serving base station TRP1 of the UE may also configure a reference signal different from an SRS reference signal in the existing positioning SRS resource set for the UE.

For example, the current serving base station TRP1 of the UE may also configure an uplink reference signal in an uplink reference signal resource set that is repeatedly sent in the same period for the UE, such as but not limited to a positioning SRS in a positioning SRS resource set that is repeatedly sent in the same period. As an example, a repetition factor (repetitionFactor) may be added to the resource mapping (resourceMapping) of the uplink positioning SRS resource (SRS-PosResource) to indicate the number of repeated transmissions in one period.

The existing positioning SRS resource set (SRS-PosResourceSet) does not support repeated transmission of the positioning SRS within a period. The configuration of this example supports repeated transmission of the positioning SRS within a period to suppress noise interference and improve positioning accuracy through repeated measurements.

In addition, when the UE supports sending multiple uplink signals simultaneously (for example, but not limited to, the UE has multiple radio frequency links and can thus send multiple data streams), the UE's current serving base station TRP1 can also configure, for the UE, uplink reference signals in multiple uplink reference signal resource sets that have the same time domain resources and are in the same partial bandwidth (Bandwidth Part, BWP), such as, but not limited to, positioning SRS in multiple SRS resource sets that have the same time domain resources and are in the same partial bandwidth, so that the UE can send these positioning SRS simultaneously. For example, the SRS resource set used for positioning may be configured similarly with reference to the configuration of the SRS resource set used for beam management in this regard. For example, a high-level usage parameter, such as “PosMeasurement”, for an SRS resource set used for positioning may be defined with reference to a high-level usage parameter “beamManagement” for an SRS resource set used for beam management. When the high-level usage parameter of such an SRS resource set for positioning is set to “PosMeasurement”, for each SRS resource set, only one SRS resource can be sent at a given time, but SRSs in multiple SRS resource sets with the same time domain resource and located in the same part of the bandwidth can be sent simultaneously. As an example, when the UE supports sending n uplink signals simultaneously (n is a natural number greater than 1), TRP1 can configure the UE to simultaneously send n SRSs with the same time domain resource and located in the same part of the bandwidth in multiple SRS resource sets for positioning.

The existing positioning SRS resource set (SRS-PosResourceSet) does not support the simultaneous transmission of positioning SRSs in multiple positioning SRS resource sets that have the same time domain resources and are located in the same bandwidth portion. By using the configuration of this example, the UE can simultaneously send SRSs used for positioning in multiple SRS resource sets for positioning, thereby facilitating improving the speed of positioning processing and reducing positioning delay.

In the case where the current serving base station TRP1 of the UE has performed the above-mentioned configuration of the uplink reference signal for the UE, accordingly, in step S605, the uplink reference signal sent from the user equipment UE or received from the user equipment UE by at least one of the multiple base stations can meet at least one of the following conditions: the uplink reference signal is an uplink reference signal in an uplink reference signal resource set and is repeatedly sent within the same period; and the uplink reference signal is an uplink reference signal in multiple uplink reference signal resource sets that has the same time domain resource and is located in the same partial bandwidth.

The above describes, in combination with FIG. 6, an example signaling interaction of a positioning process performed using positioning models and a fusion model according to an embodiment of the present disclosure.

Due to the correspondence between the training process and the usage process of the machine learning model, the example signaling interaction of the positioning process in FIG. 6, that is, the example signaling interaction of the usage process of the positioning models and the fusion model, is similarly applicable to the joint training process of the positioning models and the fusion model. The main difference between the joint training process and the positioning process shown in FIG. 6 is that the processing in step S608 is modified to obtain the positioning result PR using the fusion model and calculate the loss function based on the positioning result and the true position (for example, the loss function such as mathematical formula (3) described in the “Second Usage Example of the Positioning Model”), and for example, the Adam optimizer in the gradient backpropagation algorithm is used for optimization, and step S609 is modified to feedback the gradient to each positioning base station TRP1 and TRP2 so that the parameters of each model can be updated; thereafter, the training process can repeat the steps starting from step S601 (at this time, the updated models are used in step S606 and the modified step S608) until the optimal parameters of the positioning models and the fusion model are obtained.

### 2.1.4 Example of Determining a Positioning Base Station Group

As mentioned above, according to the present embodiment, the electronic device 300 can determine a set of base stations that meet predetermined conditions as a positioning base station group, and the predetermined conditions may, for example, include at least one of the following: the possibility that the channel between the base station and the user equipment is a line of sight is higher than a predetermined threshold; the channel quality between the base station and the user equipment is better than a predetermined threshold; the estimated distance between the base station and the user equipment is less than a predetermined threshold; the estimated distance between the base station and the serving base station of the user equipment is less than a predetermined threshold.

Among the above predetermined conditions, the first three conditions are all related to the current position of the user equipment, and the first condition may also depend on the current transmission power of the user equipment (when measured by uplink reference signal), so the base station that meets these conditions may change dynamically. Accordingly, the positioning base station group determined based on such conditions is flexible and may change in real time, which is conducive to positioning the user equipment with an appropriate base station having reliable wireless channel characteristics in real time. For example, when all four of the above conditions are applied, a base station that is closer to the user equipment, has better channel quality, and is more likely to have a direct line of sight can be determined as a positioning base station, while a base station that is far away from the user equipment and has poor channel quality is eliminated (even if the base station is adjacent to the current serving base station of the user equipment). Therefore, reliable wireless channel features can be extracted.

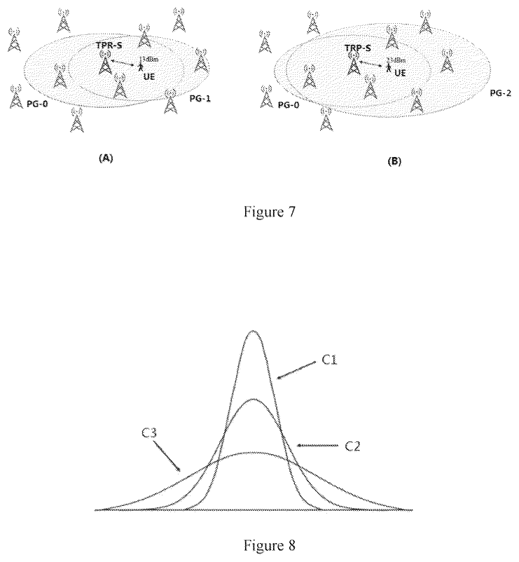

Next, an example of determining a positioning base station group according to an embodiment of the present disclosure will be described in combination with a specific example with reference to FIG. 7. FIG. 7 is a schematic diagram for explaining an example of determining a positioning base station group. In (A) and (B) of FIG. 7, the positioning base station group PG-0 within the left ellipse is determined by the electronic device 300 of this embodiment based on the condition that the estimated distance between each base station and the UE's serving base station TRP-S is less than a predetermined threshold, and includes 4 base stations including TRP-S centered on TRP-S.

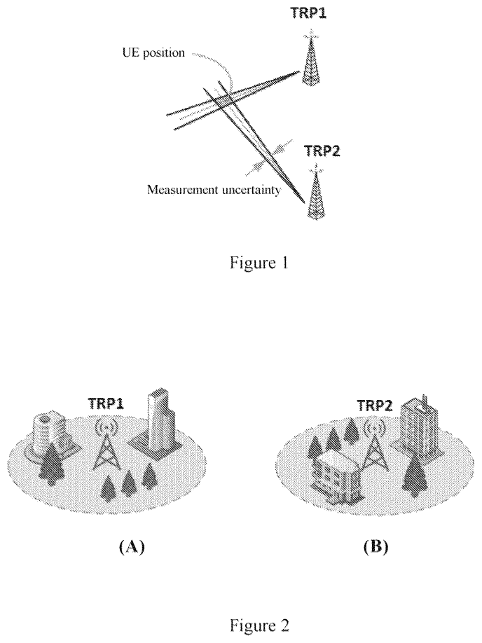

For example, when the electronic device 300 is implemented as a core network side device, it stores relevant information of each base station in the storage unit 330, so the distance between each base station and the current serving base station TRP-S of the user equipment can be directly determined, and the positioning base station group PG-0 shown in (A) and (B) of FIG. 7 can be determined accordingly. In addition, although not shown in the figure, under the control of the control unit 310, the electronic device 300 can also instruct the UE's current serving base station TRP-S and the nearest adjacent base station via the communication unit 320 to perform, for example, triangulation positioning based on AoD (see, for example, FIG. 1) to obtain the estimated position of the UE, and can determine the estimated distance between each base station and the UE based on, for example, the estimated position of the UE reported from the serving base station TRP-S, and accordingly determine the base station that meets the estimated distance regarding the UE, which will not be repeated here.

In addition, in (A) and (B) of FIG. 7, the positioning base station groups PG-1 and PG2 within the ellipse on the right are determined by the electronic device 300 of this embodiment based on the condition that the channel quality between each base station and the UE is better than a predetermined threshold. They respectively show the determined 4 or 7 base stations including TRP-S centered on the user equipment UE when the UE held by a pedestrian has different transmission powers (13 dB and 23 dB). As shown in FIG. 7, the positioning base station group PG-2 determined in the example shown in (B) where the UE has a larger transmission power includes more base stations than the positioning base station group PG-1 determined in the example shown in (A) where the UE has a smaller transmission power. This is because in the example shown in (B), the channel quality between each of a greater number of base stations and the UE is better than the predetermined threshold.

For example, through the control of the electronic device 300 as a core network device, channel quality measurements can be performed between each base station and the UE, such as RSRP measurement of the reference signal transmitted between the base station and the UE, so as to obtain the above channel quality. Alternatively or additionally, in one example, the electronic device 300 may also perform channel estimation or measurement between each base station and the UE through necessary signaling interaction, and determine the channel kurtosis of the delay domain or angle domain channel, and determine the base station with a channel kurtosis of the angle domain channel or the delay domain channel between the base station and the UE being greater than a predetermined threshold as a base station whose channel is likely to be a line of sight path higher than the predetermined threshold, and further determine it as a positioning base station in the positioning base station group. The details of the signaling interaction will be described later.

Here, it is assumed that the frequency domain channel H∈ [symbol] ^{M}^{_{Rx}}^{×M}^{_{Tx}}^{×K} has been obtained between the candidate base station and the UE through uplink or downlink measurement, where M_{Rx} is the number of antennas of the UE, M_{Tx} is the number of antennas of the candidate base station, K is the number of subcarriers, and the electronic device 300 has obtained the above-mentioned frequency domain channel H from the candidate base station or UE via the communication unit 320.

For example, the electronic device 300 may utilize the control unit 310 to perform a discrete Fourier transform (DFT) on the frequency domain channel H according to the antenna dimension of the UE or the candidate base station to obtain an angle domain channel. As an example, the electronic device 300 obtains the angle domain channel H_{ang,UE} at the UE end through the following mathematical formula (4):

$${H}_{ang , UE} = {F}_{UE} H \qquad ( 4 )$$

Wherein F_{UE}∈ [symbol] ^{M}^{_{Rx}}^{×M}^{_{Rx}} is the M_{Rx}-order DFT matrix. The electronic device 300 can also obtain the angle domain channel at the base station side in a similar manner, which will not be described in detail here.

In addition, the electronic device 300 can also use the control unit 310 to perform discrete Fourier transform on the frequency domain channel H in the subcarrier dimension through the following mathematical formula (5) to obtain the delay domain channel H_{d}

$${H}_{d} = {HF}_{d}^{H} \qquad ( 5 )$$

Wherein F_{d}∈ [symbol] ^{K×K} is the K-order DFT matrix.

For the angle domain channel or delay domain channel obtained in the above manner, the electronic device 300 may also use the control unit 310 to calculate the kurtosis of the channel.

Kurtosis is a characteristic number that characterizes the height of the peak of the probability density distribution curve at the mean value. The kurtosis can be calculated, for example, by dividing the fourth-order cumulant by the square of the second-order cumulant, that is, by dividing the fourth-order central moment by the square of the probability distribution variance minus 3 (3 represents the kurtosis of the normal distribution). If the kurtosis is greater than 3, the shape of the peak is sharper and steeper than the normal distribution peak, which can be called positive kurtosis; if the kurtosis is less than 3, it can be called negative kurtosis. FIG. 8 is a schematic diagram of distribution curves with different kurtosis (wherein the horizontal axis represents the number of samples), wherein curve C1 is a curve with positive kurtosis, curve C2 is a curve of normal distribution, and curve C3 is a curve with negative kurtosis.

Taking the delay domain channel H_{d} as a three-dimensional matrix as an example, the electronic device 300 can regard it as multiple groups of samples x=[x₁, x₂, . . . , x_{K}] with K values respectively, where each sample value is a corresponding element of the subcarrier dimension in the three-dimensional matrix of the delay domain channel H_{d}, and the delay domain channel H_{d} contains a total of M_{Rx}×M_{Tx} groups of samples. The kurtosis KURT(x) of each group of samples can be calculated by the following mathematical formula (6):

$$KURT ( x ) = \frac{\frac{1}{K} {\sum }_{i = 1}^{K} {( {x}_{i} - \overline{x} )}^{4}}{{( \frac{1}{K} {\sum }_{i = 1}^{K} {( {x}_{i} - \overline{x} )}^{2} )}^{2}} - 3 \qquad ( 6 )$$

Wherein

$$\overline{x} = \frac{1}{K} {\sum }_{i = 1}^{K} {x}_{i} .$$

Finally, the average value of the kurtosis of the M_{Rx}×M_{Tx} group samples is calculated as the kurtosis KURT of the delay domain channel H_{d}.

The electronic device 300 can also calculate the kurtosis of the angle domain channel in a similar manner, which will not be described in detail here. The electronic device may determine, as a positioning base station, a candidate base station with a kurtosis of a delay domain channel or an angle domain channel between the base station and the UE, calculated in the above manner, being greater than a predetermined threshold.

As shown in FIG. 8, the larger the kurtosis of the sample distribution is, the sharper the main peak of the sample distribution is. For an angle domain or delay domain channel, when the LOS path dominates the wireless channel, it manifests as a sharp main peak in the sample distribution of the angle domain or delay domain channel. Therefore, the angle domain or delay domain channel with larger kurtosis is more likely to have a LOS path. The LOS path is not affected by reflection or obstruction, can more accurately reflect the information such as the orientation between the UE and the base station, and has a more reliable positioning feature. Therefore, by appropriately setting the kurtosis threshold and selecting a base station that meets the threshold requirement as the positioning base station, a base station that is more likely to have a LOS path can be selected, that is, a base station that can extract more reliable wireless channel features can be selected.

Next, an example signaling interaction of the process of determining a positioning base station group according to an embodiment of the present disclosure will be described in conjunction with a specific example, which can be implemented, for example, by utilizing the interaction between the electronic device 300 (an electronic device implemented on the core network side) of the first configuration example of the above-mentioned first embodiment and related devices.

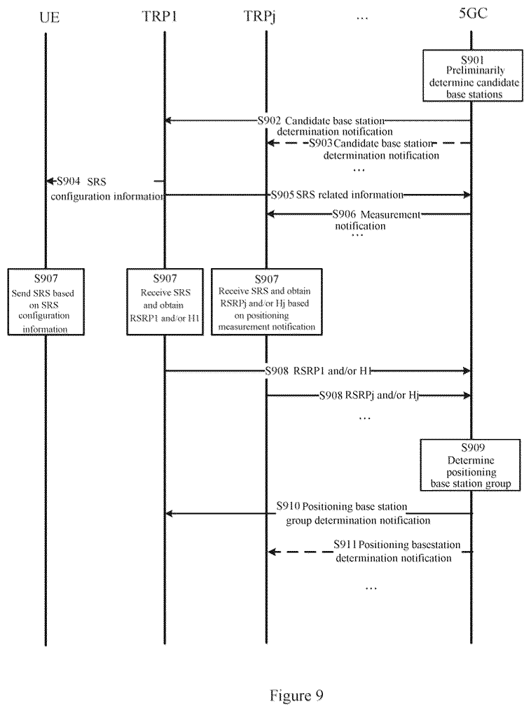

FIG. 9 is a flowchart for illustrating an example signaling interaction of a process of determining a positioning base station group according to an embodiment of the present disclosure. In the example of FIG. 9, the electronic device 300 of the first configuration example is implemented as a core network device 5GC, the user equipment that needs to be positioned is the UE, the current serving base station of the UE is TRP1, and the candidate base stations for the positioning base station include TRPj, etc. For ease of description, other candidate base stations for the positioning base station are omitted, but it can be understood that the example process can be similarly applied to a situation including more candidate base stations.

As shown in FIG. 9, first, in step S901, the core network device 5GC preliminarily determines the candidate base stations TRP1 and TRPj that meet the predetermined conditions through appropriate processing. The predetermined conditions may, for example, be the distance from the UE's current serving base station TRP1 and/or the estimated distance from the UE within a predetermined threshold.

Then, in step S902, 5GC sends a candidate base station determination notification to the UE's current serving base station TRP1, which may include, for example, the identification (ID) of each determined candidate base station and optional related information of each candidate base station, such as position information. In addition, in optional step S903, 5GC sends a candidate base station determination notification to other candidate base stations, such as TRPj, except for the current serving base station TRP1. The notification may, for example, only include indication information that the base station is determined as a candidate base station.

In step S904, the UE's current serving base station TRP1 sends, based on the received candidate base station notification, SRS configuration information to the UE, for example, via radio resource control RRC signaling, so as to configure for UE an SRS signal that can perform signal quality measurement or channel measurement with each candidate base station. TRP1 can configure, for example, an existing periodic, semi-periodic or aperiodic SRS signal for the UE, and preferably configures a periodic SRS signal to simplify the process.

In a preferred example, TRP1 may configure the UE to periodically send omnidirectional beams, for example, to sequentially send 64 or 8 beams covering the entire beam range. For this configuration, the candidate base stations can receive all beams sent by the UE in parallel with each other. Alternatively, if TRP1 can understand the positions of various candidate base stations according to the candidate base station determination notification it received in step S902, TRP1 can configure the UE to, for example, send a directional beam to each candidate base station in turn. For this configuration, each candidate base station can receive the corresponding beam sent by the UE in turn.

In addition, in step S905, TRP1 also sends information related to the configured SRS signal to 5GC. The SRS related information may include, for example, the time-frequency resources of the SRS to be sent by the UE and optional beam information. Then, in step S906, the 5GC may send a measurement notification to other candidate base stations, such as TRPj, other than the current serving base station based on the received SRS-related information, so as to notify the base station of the time-frequency resource and optional beam information used by the SRS signal to be sent by the UE.

Next, in step S907, the UE sends an SRS signal using the specified time-frequency resource (and optionally the specified beam) based on the SRS configuration information received from TRP1; the current serving base station TRP1 accordingly receives the SRS signal sent by the UE, and can obtain its received signal such as its RSRP1 and/or determine the channel H1 between the base station and the UE; other candidate base stations such as TRPj also receive the SRS signal sent by the UE based on the measurement notification, and can obtain its received signal such as its RSRPj and/or determine the channel Hj between the base station and the UE. As mentioned above, depending on the specific configuration of the SRS signal for the UE by the UE's current serving base station TRP1 (the SRS signal sent through an omnidirectional beam, or the SRS signal sent through a directional beam for each positioning base station), each candidate base station can receive all beams sent by the UE in parallel with each other, or receive the corresponding beams sent by the UE in sequence, and the present disclosure does not limit this.

Next, in step S908, each candidate base station sends the obtained received signal, such as its RSRP and/or channel, to the 5GC. In step S909, 5GC transforms the received channel to the angle domain or delay domain when necessary (for example, when the channels received from each candidate base station are frequency domain channels), and it determines the candidate base station with an angle domain or delay domain channel kurtosis with respect to the UE being greater than a predetermined threshold and/or with an RSRP of the SRS received from the UE being higher than a predetermined threshold, as a positioning base station in the positioning base station group. In this example, in addition to the UE's current serving base station TRP1, for example, TRPj is also determined as a positioning base station.

In step S910, 5GC sends a positioning base station group determination notification to the current serving base station TRP1 of the UE, which notification may include, for example, the identification (ID) of each base station in the determined positioning base station group and optional related information of each base station such as position information. In addition, in optional step S911, 5GC sends a positioning base station determination notification to other base stations in the positioning base station group except the current serving base station TRP1, such as TRPj. The notification may, for example, only include indication information that the base station is determined as a positioning base station.

Part or all of the above steps S901 to S911 may be repeatedly executed, for example, periodically executed, so as to determine or update the positioning base station group for the UE in real time.

In one example, the 5GC may have, for example, a positioning management function LMF, and optionally an access and mobility management function AMF. In this case, various signaling interactions related to positioning measurements, such as but not limited to the determination notification of the positioning base station group or the positioning base station in the above steps S910 and S911, can be performed between the LMF function in 5GC and the various candidate base stations TRP1, TRPj, etc. in NG-RAN through NRPPa (for example, via the AMF function).

### 2.1.5 Modification Example

The above describes the first configuration example of the electronic device 300 of this embodiment, namely, the electronic device implemented on the core network side and its related preferred arrangement/implementation, wherein the positioning model adopts a distributed arrangement at each base station in the positioning base station group, and the uplink reference signal sent by the user equipment is used for the positioning measurement.

However, as mentioned above, the present disclosure has no particular limitations on the arrangement of the positioning model and the reference signal used by the positioning model. Therefore, in the modified example, for example, the arrangement of the positioning model and/or the reference signal used by the positioning model may be changed. For example, in a modified example, the positioning models obtained through training at each positioning base station may be sent to the electronic device 300 implemented on the core network side, that is, each trained positioning model may be centrally arranged at the electronic device 300. In this case, the electronic device 300 may, for example, obtain received signals of uplink or downlink reference signals from multiple base stations or the user equipment, and then extract positioning information using various positioning models arranged by itself.

The electronic device 300 of the first embodiment has been described above as the first configuration example of the core network side device. Next, second and third configuration examples in which the electronic device 300 is respectively implemented on the base station side and the terminal side will be described respectively, and the difference from the first configuration example will be described emphatically while omitting unnecessary repetition.

### 2.2 Second Configuration Example

In the second configuration example, the electronic device 300 is a base station side device.

As an example, the electronic device may be the first base station among a plurality of base stations constituting a positioning base station group.

The first base station may be, for example, a current serving base station of the user equipment. In this example, preferably, the positioning models related to each base station in the positioning base station group are arranged in a distributed manner, that is, they are directly arranged in the corresponding base stations, and each base station in the positioning base station group including the first base station can extract positioning information by itself, and the base stations other than the first base station can send the extracted positioning information to the electronic device 300 serving as the first base station. Since the computing power of base stations is generally stronger than that of user equipment, distributing the positioning model in the base stations is beneficial to reducing computing delay.

More specifically, the control unit 310 of the electronic device 300 serving as the first base station may be configured to obtain positioning information of the user equipment related to the first base station based on a received signal of a reference signal transmitted between the first base station and the user equipment and using a positioning model related to the first base station. In addition, the control unit 310 of the electronic device 300 may also be configured to control the communication unit 320 to receive positioning information of the user equipment related to other base stations from other base stations among the multiple base stations except the first base station.

In this example, preferably, the reference signal used for positioning is an uplink reference signal. That is, the input of the positioning model related to each base station may be a received signal of an uplink reference signal received by the base station from the user equipment, thereby avoiding feedback overhead from the user equipment to the base station and being helpful in simplifying the signaling process. As an example, for the uplink reference signal, the SRS resources in the positioning SRS resource set (SRS-PosResourceSet) can be used.

In the second configuration example, compared with the case of the first configuration example, for base stations other than the first base station in the positioning base station group, the main difference is that the destination for sending positioning information (and optionally, the source for receiving measurement notifications and determining results, etc.) is changed from the core network device to the first base station, and other operations are basically the same or similar to those described in the first configuration example. In addition, in the second configuration example, compared with the first configuration example, for an electronic device that serves as the first base station in a positioning base station group (for example, the current serving base station of a user device) rather than an electronic device that serves as a core network device, the difference mainly lies in the addition of a function of extracting positioning information using its own positioning model, and other operations are basically the same or similar to those described in the first configuration example.

Therefore, various usage examples of the positioning model described above in the first configuration example can be similarly applied to the second configuration example.

In addition, the example signaling interaction of the positioning process described above in the first configuration example can be similarly applied to the second configuration example after appropriate modification. For example, in the example signaling interaction shown in FIG. 6, in this case, instead of the core network device 5GC initiating positioning measurement, obtaining positioning information and obtaining positioning results, the first base station, such as the current serving base station TRP1 of the user equipment, initiates positioning measurement (sending positioning measurement notifications to other positioning base stations), and TRP1 obtains the positioning information of other positioning base stations, and then TRP1 determines the positioning result. In this case, TRP1 can, for example, communicate directly with other positioning base stations (for example, via device-to-device (D2D) communication or Sidelink communication), or TRP1 and the other positioning base stations can communicate with each other using 5GC as a relay. Note that in this case, TRP1 serves as the current serving base station of the user equipment UE, and it still performs SRS configuration for the UE. Similarly, the determination of the positioning base station group described in the first configuration example and the related signaling interaction shown in FIG. 9 can be similarly applied to the second configuration example after appropriate modifications (for example, adding processing or steps for the first base station, such as the current serving base station TRP1, to obtain relevant information from the 5GC).

In addition, although in the second configuration example, positioning models related to respective base stations in the positioning base station group are preferably distributed and arranged at respective base stations, and uplink reference signals are preferably used in positioning measurement, the second configuration example is not limited thereto. As a modification example, for example, positioning models related to various base stations may be centrally arranged at the user equipment, and a downlink reference signal may be used in the measurement. In this case, the first base station in the positioning base station group (for example, the current serving base station of the user equipment) obtains positioning information (downlink reference signal) extracted by the user equipment using multiple positioning models from the user equipment, and then performs fusion calculation or fusion processing.

### 2.3 Third Configuration Example

In the third configuration example, the electronic device 300 is a terminal-side device.

As an example, the electronic device may be a user device to be positioned.

In this example, preferably, the positioning models related to each base station in the positioning base station group are centrally arranged at the user equipment. For example, a positioning model of each positioning base station may first be trained at the positioning base station, and then sent to the electronic device 300 as the user equipment.

In this case, the control unit 310 of the electronic device 300 serving as a user device can be configured to obtain the positioning information of the user device related to the base station based on the received signal of the reference signal transmitted between each base station in multiple base stations and the user device and using the positioning model related to the base station. In this example, preferably, the reference signal used for positioning is a downlink reference signal. That is, the input of each positioning model respectively associated with each base station and arranged at the electronic device 300 serving as a user device can be the received signal of the downlink reference signal received by the electronic device 300 from the corresponding base station, thereby avoiding the overhead of the user equipment obtaining the received signal from the corresponding base station and helping to simplify the signaling process. As an example, the downlink reference signal may be a positioning reference signal PRS.

In the third configuration example, compared with the first configuration example, the base stations in the positioning base station group mainly differ in that they no longer extract positioning information by themselves, but only send downlink reference signals to the electronic device 300 as the user equipment. In addition, in the third configuration example, compared with the first configuration example, for an electronic device that serves as a user device rather than an electronic device that serves as a core network device, the main difference lies in the addition of a function of receiving a downlink reference signal from each base station in the positioning base station group and extracting corresponding positioning information using each deployed positioning model, and other operations are basically the same or similar to those described in the first configuration example.

Therefore, various usage examples of the positioning model described above in the first configuration example can be similarly applied to the third configuration example. In addition, the example signaling interaction of the positioning process described above in the first configuration example can be similarly applied to the third configuration example after appropriate modification. For example, in the example signaling interaction shown in FIG. 6, at this time, instead of the core network device 5GC initiating the positioning measurement, the user equipment UE initiates the positioning measurement, and the UE obtains the positioning information and determines the positioning result based on the received signal of the reference signal transmitted between each positioning base station and the UE. In this case, the UE can, for example, communicate with other positioning base stations via its serving base station TRP1 (for example, via D2D communication or Sidelink communication between base stations), or can communicate with other positioning base stations via its serving base station TRP1 and using 5GC as a relay. Similarly, the determination of the positioning base station group described in the first configuration example and the related signaling interaction shown in FIG. 9 can be similarly applied to the third configuration example after appropriate modifications (for example, also adding processing or steps for the UE to obtain relevant information from the 5GC).

In addition, although in the third configuration example, the positioning models related to the respective base stations in the positioning base station group are preferably centrally arranged at the electronic device as the user equipment and the downlink reference signal is preferably used in the positioning measurement, the third configuration example is not limited thereto. As a modification example, for example, positioning models related to various base stations may be distributed and arranged at various positioning base stations, and uplink reference signals may be used in measurement. In this case, the electronic device as the user equipment obtains the positioning information extracted by using the corresponding positioning model from each base station in the positioning base station group, and then performs fusion calculation or fusion processing.

The above describes an electronic device according to the first embodiment of the present disclosure, which is capable of acquiring, through interaction with related devices or directly acquiring, a plurality of pieces of positioning information for a user equipment extracted using positioning models related to each positioning base station, and obtaining a positioning result for the user equipment based on the positioning information.

In the description of the first embodiment above, in addition to the first device for obtaining a positioning result based on positioning information according to the first embodiment, a second device (for example, each positioning base station described in the first configuration example, a positioning base station other than the first base station described in the second configuration example, each positioning base station described in the modified example of the third configuration example, etc.) which is arranged with a positioning model and uses the positioning model to extract positioning information of a user device for use by the first device is also described, and a third device, i.e., a user device (for example, the user device described in the first configuration example or the second configuration example) which interacts with the positioning base station in order to provide input (a received signal of a reference signal) to a related device arranged with a positioning model, is also described. In other words, the inventors have made the second and third embodiments of the present disclosure for the above-mentioned second and third devices. An outline description of the second and third embodiments will be given below based on the description of the first embodiment, while omitting unnecessary details thereof.

### 3. Configuration Example of Electronic Device of Second Embodiment

The electronic device of the second embodiment may have a functional block diagram similar to that of the electronic device of the first embodiment. That is, the electronic device of the second embodiment may have the form of the electronic device 300 shown in FIG. 3, and include a control unit 310 and a communication unit 320 and an optional storage unit 330. The electronic device 300 of the second embodiment is preferably a base station side device.

According to the second embodiment, the control unit 310 of the electronic device 300 can obtain the positioning information of the user equipment related to the subject base station based on the received signal of the reference signal transmitted between the subject base station and the user equipment and using the positioning model related to the base station. In addition, the control unit 310 can also control the communication unit 320 to provide the positioning information of the user equipment related to the subject base station to another electronic device, so that the other electronic device can obtain the positioning result of the user equipment based on a plurality of pieces of positioning information of the user equipment respectively related to multiple base stations including the subject base station, wherein the plurality of pieces of positioning information of the user equipment have the same form as each other.

Here, the “another electronic device” used to obtain the positioning result of the user equipment can be the electronic device (first device) in each configuration previously described in the first embodiment, and the multiple base stations including the subject base station can be the positioning base station group previously described in the first embodiment. Preferably, the electronic device 300 of this embodiment may be a subject base station among multiple base stations constituting a positioning base station group, and it may be, for example, the various positioning base stations described in the first configuration example of the first embodiment, the positioning base stations other than the first base station described in the second configuration example, the various positioning base stations described in the modified example of the third configuration example, and the like. Preferably, in this example, the reference signal is an uplink reference signal.

### 3. Configuration Example of Electronic Device of Third Embodiment

The electronic device of the third embodiment may have a functional block diagram similar to that of the electronic device of the first embodiment. That is, the electronic device of the third embodiment may have the form of the electronic device 300 shown in FIG. 3, and include a control unit 310 and a communication unit 320 and an optional storage unit 330. The electronic device 300 of the third embodiment is preferably a terminal-side device.

According to the third embodiment, the control unit 310 of the electronic device 300 can control the communication unit 320 to send or receive reference signals with each of the multiple base stations respectively, so that each of the multiple base stations can obtain the positioning information of the electronic device related to the base station based on the received signal of the reference signal transmitted between the base station and the electronic device and using the positioning model related to the base station, wherein pieces of positioning information of the electronic device related to the respective ones of the multiple base stations have the same form.

Here, the multiple base stations interacting with the electronic device 300 as a terminal side device may be the respective base stations in the positioning base station group described previously in the first embodiment. Preferably, the electronic device 300 of this embodiment may be a user equipment to be positioned, which may be, for example, the user equipment described in the first configuration example or the second configuration example of the first embodiment. Preferably, in this example, the reference signal is an uplink reference signal.

### 5. Simulation Results

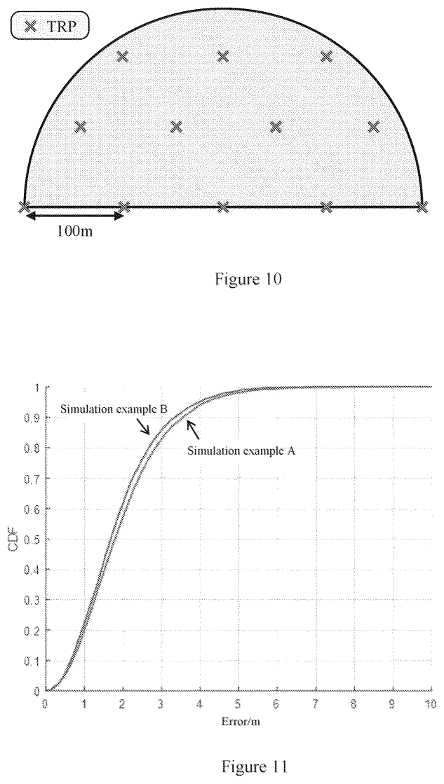

Next, the simulation results of the positioning process according to the embodiment of the present disclosure will be described in conjunction with the example of FIG. 10. FIG. 10 is a schematic diagram of candidate base stations that may be used for positioning in a simulation example of a positioning process according to an embodiment of the present disclosure, wherein a positioning scenario is shown in which a semicircular area with a radius of 200 meters includes 12 candidate base stations. A user equipment not shown in the figure can be located at any position (random position) within the semicircular area, and the current serving base station of the user equipment can be one of the 12 candidate base stations determined based on the channel quality between the user equipment and the 12 candidate base stations (for example, the base station with the largest RSRP with respect to the user equipment can be used as the serving base station). Each base station includes a LOS scenario and a NLOS scenario, and each base station and user equipment uses a uniform linear array (ULA).

In simulation example A and simulation example B, the electronic device 300 of the first configuration example of the first embodiment, namely the core network device 5GC, is used. Through the positioning process shown in FIG. 6, the uplink reference signal, namely the positioning SRS, is used as the input of the positioning model to obtain the positioning result of the user equipment UE. The difference between the two simulation examples lies in the selection of the positioning base station group. In simulation example A, all 12 candidate base stations in FIG. 10 are used as the positioning base station group; in simulation example B, the base stations among the 12 candidate base stations in FIG. 10 whose RSRP with respect to the user equipment UE is greater than the RSRP threshold (RSRP threshold η=−88 dBm) are used as the positioning base station group. The existing COST2100 wireless channel model is used to generate channel data. The simulation parameters are shown in Table 1.

TABLE 1

| Center frequency | 28 | GHz |
|---|---|---|
| Number of base station antennas (ULA) | 64 | |
| Number of base station beams | 64 | |
| Number of user equipment antennas | 8 | |
| (ULA) | | |
| Number of user equipment beams | 8 | |
| Bandwidth | 100 | MHz |
| User equipment transmission power | 20 | dBm |
| Cell radius | 50 | m |
| Noise power | −174 | dBm/Hz |
| Noise factor | 6 | dB |

Based on the above simulation conditions and simulation parameters, in simulation example A and simulation example B, 5000 simulations of the positioning process are performed respectively, with only the position of the user equipment being changed while other conditions remain unchanged. The position of the user equipment in each simulation can be randomly determined within the semicircular area shown in FIG. 10. The average positioning error E is used as the evaluation index. Assuming that the predicted position of the user equipment UE obtained through simulation is pₚᵣₑ=(xₚᵣₑ, yₚᵣₑ), and the actual position of the user equipment UE is p=(x, y), the positioning error Error can be calculated in a manner similar to mathematical formula (3):

$$Error = \vert p - {p}_{pre} \vert = \sqrt[2]{{( x - {x}_{pre} )}^{2} + {( y - {y}_{pre} )}^{2}}$$

FIG. 11 shows the cumulative distribution function (CDF) of the positioning errors of simulation examples A and B, where the positioning errors in the range of 50%, 90% and 99% are shown in Table 2. It can be seen that the median positioning error of simulation example B is only 1.67 meters, which has a smaller positioning error than simulation example A. At the same time, as shown in Table 2, simulation example B only requires uplink measurements of 5.85 positioning base stations on average, and therefore has a smaller positioning overhead.

TABLE 2

| Simulation example | A | B |
|---|---|---|
| 50% error | 1.79 m | 1.67 m |
| 90% error | 3.55 m | 3.33 m |
| 99% error | 5.60 m | 5.10 m |
| Average number of | 12 | 5.85 |
| positioning base stations | | |

### 6. Method Example

Corresponding to the above-mentioned device embodiments, the present disclosure provides the following method embodiments.

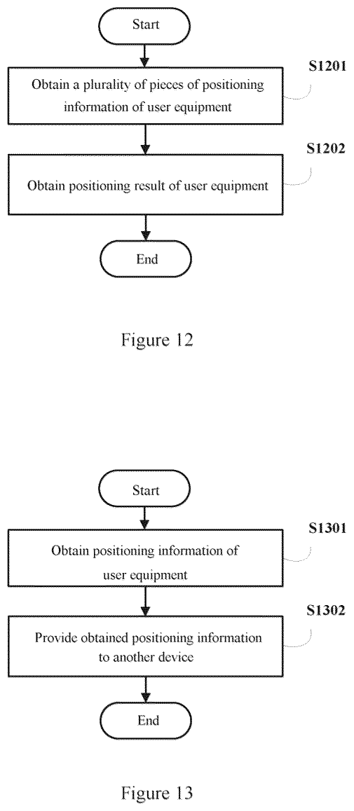

FIG. 12 is a flowchart showing a process example of a method for wireless communication according to the first embodiment of the present disclosure.

As shown in FIG. 12, in step S1201, a plurality of pieces of positioning information of the user equipment respectively related to each base station in a plurality of base stations is obtained, wherein the positioning information of the user equipment related to each base station is obtained based on a received signal of a reference signal transmitted between the base station and the user equipment and using a positioning model related to the base station, and the plurality of pieces of positioning information of the user equipment have the same form as each other.

Next, in step S1202, a positioning result of the user equipment is obtained based on the plurality of pieces of positioning information of the user equipment.

The multiple base stations involved in step S1201 may be collectively referred to as a positioning base station group, wherein each base station may be referred to as a positioning base station. Optionally, each of the multiple base stations in the positioning base station group satisfies at least one of the following conditions: the possibility that the channel between the base station and the user equipment is a line of sight is higher than a predetermined threshold; the channel quality between the base station and the user equipment is better than a predetermined threshold; the estimated distance between the base station and the user equipment is less than a predetermined threshold; the estimated distance between the base station and the serving base station is less than a predetermined threshold.

In the first usage example of the positioning model, the positioning model of each base station is pre-acquired through training using received signals of reference signals transmitted between the base station and one or more user equipments with known positions as training data. As an example, the form of positioning information includes at least one of the following: the position of the user device; the position of the user device and confidence; the probability distribution of the position of the user device. In this case, in step S1202, based on the plurality of pieces of positioning information of the user equipment, a positioning result of the user equipment is obtained by using a simple fusion calculation.

In the second usage example of the positioning model, in step S1202, based on the plurality of pieces of positioning information of the user equipment, a fusion model is used to obtain a positioning result of the user equipment. As an example, the positioning model of each of the multiple base stations and the fusion model are pre-obtained through joint training using the received signals of reference signals transmitted between each of the multiple base stations and one or more user devices with known positions as training data.

In a first execution example of the method of this embodiment, the example method shown in FIG. 12 is executed on the core network side. In this case, preferably, the positioning models are distributed and arranged at each positioning base station, and in step S1201, the plurality of pieces of positioning information are obtained by respectively receiving the positioning information of the user equipment related to each base station from the multiple base stations.

In a second execution example of the method of this embodiment, the example method shown in FIG. 12 is executed on the side of one base station among multiple base stations. In this case, preferably, the positioning models are distributed and arranged at each positioning base station, and in step S1201, the plurality of pieces of positioning information are obtained in the following manner: based on the received signal of the reference signal transmitted between the first base station and the user equipment, using the positioning model related to the first base station, the positioning information of the user equipment related to the first base station is obtained; and the positioning information of the user equipment related to other base stations among multiple base stations except the first base station is received from the other base stations.

In the above first and second execution examples, optionally, the reference signal used in the positioning measurement may be an uplink reference signal. Optionally, an uplink reference signal received by at least one of the multiple base stations from the user equipment satisfies at least one of the following conditions: the uplink reference signal is an uplink reference signal in an uplink reference signal resource set and is repeatedly sent within the same period; and the uplink reference signal is an uplink reference signal in multiple uplink reference signal resource sets that has the same time domain resource and is located in the same partial bandwidth and is sent simultaneously.

In a third execution example of the method of this embodiment, the example method shown in FIG. 12 is executed on the user equipment side. In this case, preferably, the positioning model is centrally arranged at the user equipment, and in step S1201, the plurality of pieces of positioning information is obtained in the following manner: based on the received signal of the reference signal transmitted between each base station in the multiple base stations and the user equipment, and using the positioning model related to the base station, the positioning information of the user equipment related to the base station is obtained.

In the above third execution example, optionally, the reference signal used in the positioning measurement is a downlink reference signal.

According to an embodiment of the present disclosure, the subject executing the above method may be an electronic device according to the first embodiment of the present disclosure, and therefore all the embodiments of the electronic device of the first embodiment in the foregoing text are applicable hereto.

FIG. 13 is a flowchart showing a process example of a method for wireless communication according to the second embodiment of the present disclosure.

As shown in FIG. 13, in step S1301, based on the received signal of the reference signal transmitted between the base station and the user equipment, the positioning information of the user equipment related to the base station is acquired using the positioning model related to the base station.

Next, in step S1302, the positioning information of the user equipment related to this base station is provided to another electronic device, so that the other electronic device can obtain the positioning result of the user equipment based on a plurality of pieces of positioning information of the user equipment respectively related to multiple base stations including this base station, wherein the plurality of pieces of positioning information of the user equipment have the same form as each other.

The multiple base stations involved in step S1301 may be collectively referred to as a positioning base station group, wherein each base station may be referred to as a positioning base station. In one example, the example method shown in FIG. 13 is performed at a base station among multiple base stations. In this case, preferably, multiple positioning models are distributed and arranged at each positioning base station, and the reference signal used in the positioning measurement may be an uplink reference signal.

According to an embodiment of the present disclosure, the subject executing the above method may be an electronic device according to the second embodiment of the present disclosure, and therefore all the embodiments of the electronic device of the second embodiment in the foregoing text are applicable hereto.

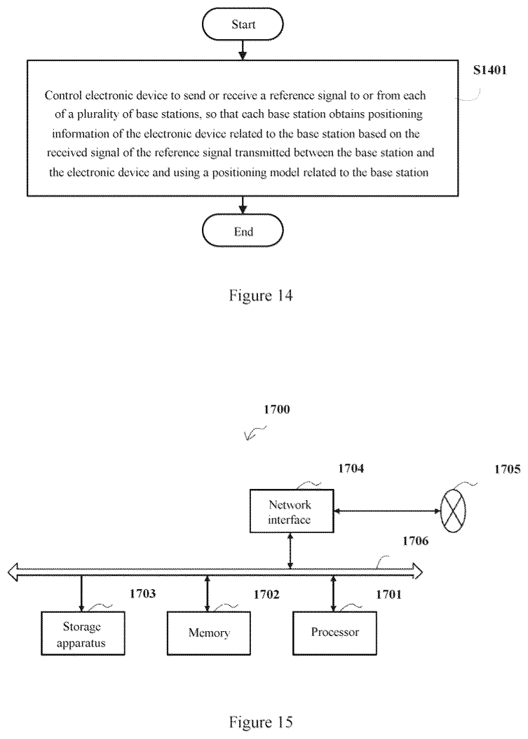

FIG. 14 is a flowchart showing a process example of a method for wireless communication according to the third embodiment of the present disclosure.

As shown in FIG. 14, in step S1401, the electronic device is controlled to send or receive a reference signal to each of the multiple base stations, so that each of the multiple base stations can obtain the positioning information of the electronic device related to the base station based on the received signal of the reference signal transmitted between the base station and the electronic device and using the positioning model related to the base station, wherein the positioning information of the electronic device related to each of the multiple base stations has the same form.

The example method shown in FIG. 14 may be performed at an electronic device to be positioned.

According to an embodiment of the present disclosure, the subject that executes the above method may be an electronic device according to the third embodiment of the present disclosure, and therefore all the embodiments of the electronic device of the third embodiment in the foregoing text are applicable hereto.

### 7. Application Examples

The technology of the present disclosure can be applied to various products.

For example, the electronic device of the first configuration example of the first embodiment may be implemented on the core network side. The electronic device may be implemented as any type of control entity, for example, various types of servers, such as a tower server, a rack server, and a blade server. The electronic device may be a control module mounted on a server (such as an integrated circuit module including a single chip, and a card or blade inserted into a slot of a blade server).

Furthermore, the electronic device of the second configuration example of the first embodiment as well as the electronic device of the second embodiment may be implemented on the base station side. When the electronic device is implemented on the base station side, the electronic device can be implemented as any type of base station device, such as macro eNB and small eNB, and can also be implemented as any type of gNB (base station in the 5G system). A small eNB may be an eNB covering a cell smaller than a macro cell, such as a pico eNB, a micro eNB, and a home (femto) eNB. Alternatively, the base station may be implemented as any other type of base station, such as a NodeB and a Base Transceiver Station (BTS). The base station may include: a main body (also referred to as a base station device) configured to control wireless communication; and one or more remote radio heads (RRHs) provided at a position different from the main body.

The electronic device on the base station side can also be implemented as any type of TRP. The TRP may have sending and receiving functions, for example, it may receive information from a user device and a base station device, and may also send information to a user device and a base station device. In a typical example, the TRP can provide services to the user equipment and is controlled by the base station equipment. Furthermore, the TRP may have a structure similar to that of a base station device, or may only have a structure related to sending and receiving information in a base station device.

In addition, the electronic device of the third configuration example of the first embodiment as well as the electronic device of the third embodiment may be implemented on the terminal side. When an electronic device is implemented on the terminal side, for example, as a terminal device, the electronic device can be various user devices, which can be implemented as a mobile terminal (such as a smart phone, a tablet personal computer (PC), a notebook PC, a portable game terminal, a portable/dongle type mobile router, and a digital camera device) or a vehicle-mounted terminal (such as a car navigation device). The user equipment may also be implemented as a terminal performing machine-to-machine (M2M) communication (also referred to as a machine type communication (MTC) terminal). Furthermore, the user equipment may be a wireless communication module (such as an integrated circuit module including a single chip) installed on each of the above-mentioned user equipments.

### Application Examples Regarding Control Entities

FIG. 15 is a block diagram illustrating an example of a schematic configuration of a server 1700 to which the technology of the present disclosure can be applied. The server 1700 includes a processor 1701, a memory 1702, a storage apparatus 1703, a network interface 1704, and a bus 1706.

The processor 1701 may be, for example, a central processing unit (CPU) or a digital signal processor (DSP), and controls functions of the server 1700. The memory 1702 includes a random access memory (RAM) and a read only memory (ROM), and stores data and a program executed by the processor 1701. The storage apparatus 1703 may include storage media such as a semiconductor memory and a hard disk.

The network interface 1704 is a wired communication interface for connecting the server 1700 to the wired communication network 1705. The wired communication network 1705 may be a core network such as an evolved packet core (EPC) or a packet data network (PDN) such as the Internet.

The bus 1706 connects the processor 1701, the memory 1702, the storage apparatus 1703, and the network interface 1704 to one another. The bus 1706 may include two or more buses each having a different speed (such as a high-speed bus and a low-speed bus).

In the server 1700 shown in FIG. 15, the control unit in the electronic device 300 of the first configuration example of the first embodiment described hereinbefore with reference to FIG. 3 may be implemented by a processor 1701. For example, the processor 1701 may perform the functions of the above-mentioned control unit by executing instructions stored in the memory 1702 or the storage apparatus 1703. Furthermore, the communication unit in the electronic device 300 may be implemented via the network interface 1704 or the like. In addition, the storage unit in the electronic device 300 may be implemented by the memory 1702 and/or the storage apparatus 1703.

### Application Example about Base Station

### First Application Example

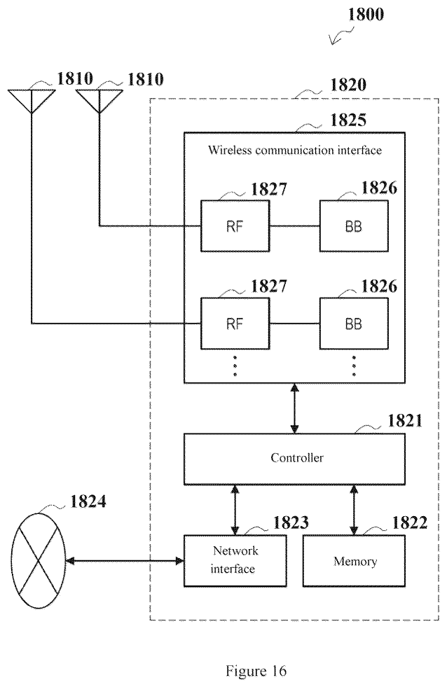

FIG. 16 is a block diagram showing a first example of a schematic configuration of an eNB in which the technique of the disclosure can be applied. The eNB 1800 includes a single or multiple antennas 1810 and a base station equipment 1820. The base station equipment 1820 and each antenna 1810 may be connected with each other via RF cable.

Each of the antennas 1810 includes one or more antenna elements (such as multiple antenna elements included in a multiple-input multiple-output (MIMO) antenna), and are used for transmitting and receiving a wireless signal by the base station equipment 1820. The eNB 1800 may include the multiple antennas 1810, as illustrated in FIG. 16. For example, the multiple antennas 1810 may be compatible with multiple frequency bands used by the eNB 1800. Although FIG. 16 illustrates an example in which the eNB 1800 includes multiple antennas 1810, the eNB 1800 may also include a single antenna 1810.

The base station equipment 1820 includes a controller 1821, a memory 1822, a network interface 1823, and a wireless communication interface 1825.

The controller 1821 may be, for example, a CPU or a DSP and operate various functions of higher layers of the base station equipment 1820. For example, the controller 1821 generates a data packet based on data in a signal processed by the wireless communication interface 1825, and transmits the generated packet via the network interface 1823. The controller 1821 may bundle data from multiple baseband processors to generate a bundled packet and transmit the generated bundled packet. The controller 1821 may have logic functions for performing the following control: wireless resource control, radio carrying control, mobility management, admission control and schedule. The control may be performed in corporation with a nearby eNB or core network node. The memory 1822 includes an RAM and an ROM, and stores a program executed by the controller 1821 and various types of control data (such as a terminal list, transmission power data and scheduling data).

The network interface 1823 is configured to connect the base station equipment 1820 to a communication interface of the core network 1824. The controller 1821 may communicate with a core network node or another eNB via the network interface 1823. In this case, the eNB 1800 and the core network node or another eNB may be connected to each other via a logic interface (such as an S1 interface and an X2 interface). The network interface 1823 may be a wired communication interface or a wireless communication interface for a wireless backhaul line. If the network interface 1823 is a wireless communication interface, the network interface 1823 may use a higher frequency band for radio communication as compared with the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via the antenna 1810. The wireless communication interface 1825 may generally include a base band (BB) processor 1826 and an RF circuit 1827. The BB processor 1826 may perform, for example, encoding/decoding, modulating/demodulating, and multiplexing/de-multiplexing, and perform various types of signal processing of layers (such as L1, medium access control (MAC), radio link control (RLC), and packet data convergence protocol (PDCP)). Instead of the controller 1821, the BB processor 1826 may have a part or all of the above-mentioned logic functions. The BB processor 1826 may be a memory storing communication control programs, or a module including a processor which is configured to execute the programs and a related circuit. Update of the programs may change the function of the BB processor 1826. The module may be a card or a blade inserted into a slot of the base station equipment 1820. Alternatively, the module may be a chip installed on the card or the blade. Meanwhile, the RF circuit 1827 may include for example a mixer, a filter or an amplifier, and transmits and receives a radio signal via the antenna 1810.

The wireless communication interface 1825 may include multiple BB processors 1826, as illustrated in FIG. 16. For example, the multiple BB processors 1826 may be compatible with multiple frequency bands used by the eNB 1800. As shown in FIG. 16, the wireless communication interface 1825 may include multiple RF circuits 1827. For example, the multiple RF circuits 1827 may be compatible with multiple antenna elements. Although FIG. 16 shows the example in which the wireless communication interface 1825 includes the multiple BB processors 1826 and the multiple RF circuits 1827, the wireless communication interface 1825 may also include a single BB processor 1826 or a single RF circuit 1827.

In the eNB 1800 shown in FIG. 16, the communication unit in the electronic device 300 in the second configuration example of the first embodiment and in the second embodiment described previously with reference to FIG. 3 may be implemented through the wireless communication interface 1825 and optionally the antenna 1810. The function of the control unit in the electronic device 300 may be implemented by the controller 1821. For example, the controller 1821 may implement the function of the control unit by executing instructions stored in the memory 1822. In addition, the storage unit in the electronic device 300 can be implemented by the memory 1822.

### Second Application Example

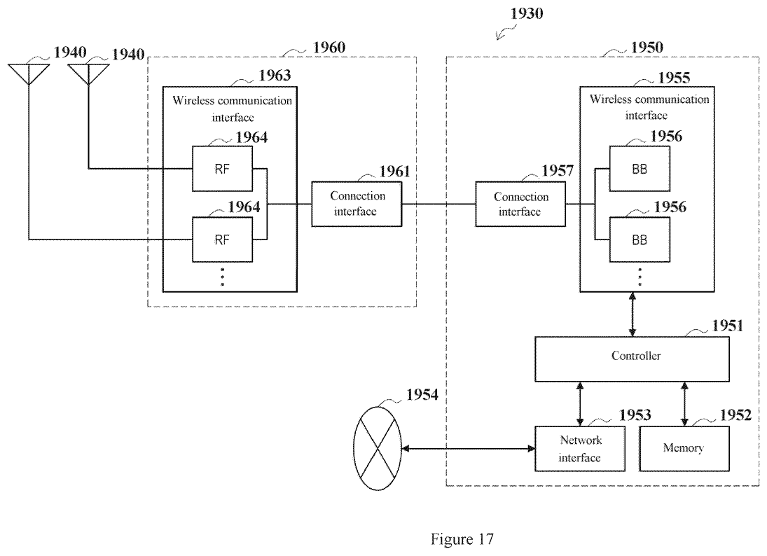

FIG. 17 is a block diagram showing a second example of a schematic configuration of an eNB to which the technology of the present disclosure can be applied. An eNB 1930 includes one or more antennas 1940, a base station equipment 1950 and an RRH 1960. The RRH 1960 and each antenna 1940 may be connected to each other via an RF cable. The base station equipment 1950 and the RRH 1960 may be connected to each other via a high speed line such as an optical fiber cable.

Each of the antennas 1940 includes a single or multiple antenna elements (such as multiple antenna elements included in an MIMO antenna), and is used for the RRH 1960 to transmit and receive radio signals. As shown in FIG. 17, the eNB 1930 may include multiple antennas 1940. For example, the multiple antennas 1940 may be compatible with multiple frequency bands used by the eNB 1930. Although FIG. 17 illustrates an example in which the eNB 1930 includes multiple antennas 1940, the eNB 1930 may also include a single antenna 1940.

The base station equipment 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 16.

The wireless communication interface 1955 supports any cellular communication solution (such as LTE and LTE-advanced), and provides wireless communication with a terminal located in a sector corresponding to the RRH 1960 via the RRH 1960 and the antenna 1940. The wireless communication interface 1955 may typically include a BB processor 1956 for example. The BB processor 1956 is the same as the BB processor 1826 described with reference to FIG. 16, except that the BB processor 1956 is connected to the RF circuitry 1964 of the RRH 1960 via the connection interface 1957. As show in FIG. 17, the wireless communication interface 1955 may include multiple BB processors 1956. For example, the multiple BB processors 1956 may be compatible with the multiple frequency bands used by the eNB 1930. Although FIG. 17 shows an example in which the wireless communication interface 1955 includes multiple BB processors 1956, the wireless communication interface 1955 may include a single BB processor 1956.

The connection interface 1957 is an interface for connecting the base station equipment 1950 (wireless communication interface 1955) to the RRH 1960. The connection interface 1957 may also be a communication module for communication in the above-described high-speed line via which the base station equipment 1950 (wireless communication interface 1955) is connected to the RRH 1960.

The RRH 1960 includes a connection interface 1961 and a wireless communication interface 1963.

The connection interface 1961 is an interface for connecting the RRH 1960 (the wireless communication interface 1963) to the base station equipment 1950. The connection interface 1961 may also be a communication module for the communication in the above high-speed line.

The wireless communication interface 1963 transmits and receives a wireless signal via the antenna 1940. The wireless communication interface 1963 may typically include, for example, the RF circuit 1964. The RF circuit 1964 may include for example frequency mixer, a filter and an amplifier, and transmits and receives a wireless signal via the antenna 1940. The wireless communication interface 1963 may include multiple RF circuits 1964, as illustrated in FIG. 17. For example, the multiple RF circuits 1964 may support multiple antenna elements. Although FIG. 17 shows an example in which the wireless communication interface 1963 includes the multiple RF circuits 1964, the wireless communication interface 1963 may also include a single RF circuit 1964.

In the eNB 1930 shown in FIG. 17, the communication unit in the electronic device 300 in the second configuration example of the first embodiment and in the second embodiment described previously with reference to FIG. 3 may be implemented, for example, by the wireless communication interface 1963 and optionally the antenna 1940. The function of the control unit in the electronic device 300 may be implemented by the controller 1951. For example, the controller 1951 may implement the function of the control unit by executing instructions stored in the memory 1952. In addition, the storage unit in the electronic device 300 can be implemented by the memory 1952.

### Application Example on User Equipment

### First Application Example

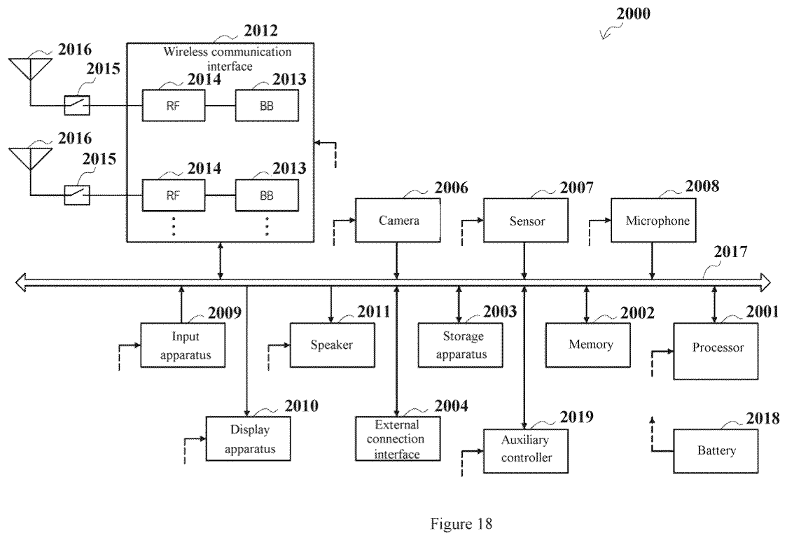

FIG. 18 is a block diagram illustrating an example of exemplary configuration of a smartphone 2000 to which the technology of the present disclosure can be applied. The smartphone 2000 includes a processor 2001, a memory 2002, a storage apparatus 2003, an external connection interface 2004, a camera 2006, a sensor 2007, a microphone 2008, an input apparatus 2009, a display apparatus 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on chip (SoC), and control functions of an application layer and additional layer of the smartphone 2000. The memory 2002 includes RAM and ROM, and stores a program that is executed by the processor 2001, and data. The storage apparatus 2003 may include a storage medium such as a semiconductor memory and a hard disk. The external connection interface 2004 is an interface configured to connect an external apparatus (such as a memory card and a universal serial bus (USB) apparatus) to the smart phone 2000.

The camera 2006 includes an image sensor (such as a Charge Coupled Device (CCD) and a Complementary Metal Oxide Semiconductor (CMOS)) and generates a captured image. The sensor 2007 may include a group of sensors such as a measurement sensor, a gyro sensor, a geomagnetic sensor, and an acceleration sensor. The microphone 2008 converts sounds that are inputted to the smart phone 2000 into audio signals. The input apparatus 2009 includes, for example, a touch sensor configured to detect touch onto a screen of the display apparatus 2010, a keypad, a keyboard, a button, or a switch, and receive an operation or information inputted from a user. The display apparatus 2010 includes a screen (such as a liquid crystal display (LCD) and an organic light-emitting diode (OLED) display), and displays an output image of the smartphone 2000. The speaker 2011 converts audio signals that are outputted from the smart phone 2000 to sounds.

The wireless communication interface 2012 supports any cellular communication scheme (such as LTE and LTE-advanced), and performs wireless communication. The wireless communication interface 2012 may generally include for example a BB processor 2013 and an RF circuit 2014. The BB processor 2013 may perform encoding/decoding, modulating/demodulating and multiplexing/de-multiplexing for example, and perform various types of signal processing for wireless communication. Meanwhile, the RF circuit 2014 may include for example a mixer, a filter and an amplifier, and transmit and receive a wireless signal via the antenna 2016. The wireless communication interface 2012 may be a chip module having the BB processor 2013 and the RF circuit 2014 integrated thereon. As shown in FIG. 18, the wireless communication interface 2012 may include multiple BB processors 2013 and multiple RF circuits 2014. Although FIG. 18 illustrates the example in which the wireless communication interface 2012 includes the multiple BB processors 2013 and the multiple RF circuits 2014, the wireless communication interface 2012 may also include a single BB processor 2013 or a single RF circuit 2014.

Furthermore, in addition to a cellular communication scheme, the wireless communication interface 2012 may support another type of wireless communication scheme such as a short-distance wireless communication scheme, a near field communication scheme, and a wireless local area network (LAN) scheme. In this case, the wireless communication interface 2012 may include the BB processor 2013 and the RF circuit 2014 for each wireless communication scheme.

Each of the antenna switches 2015 switches connection destinations of the antennas 916 among multiple circuits (such as circuits for different wireless communication schemes) included in the wireless communication interface 2012.

Each of the antennas 2016 includes a single or multiple antenna elements (such as multiple antenna elements included in an MIMO antenna), and is used for the wireless communication interface 2012 to transmit and receive radio signals. The smartphone 2000 may include the multiple antennas 2016, as illustrated in FIG. 18. Although FIG. 18 illustrates the example in which the smartphone 2000 includes the multiple antennas 2016, the smartphone 2000 may also include a single antenna 2016.

In addition, the smartphone 2000 may include an antenna 2016 for each wireless communication scheme. In this case, the antenna switch 2015 may be omitted from the configuration of the smartphone 2000.

The bus 2017 connects the processor 2001, the memory 2002, the storage apparatus 2003, the external connection interface 2004, the camera 2006, the sensor 2007, the microphone 2008, the input apparatus 2009, the display apparatus 2010, the speaker 2011, the wireless communication interface 2012, and the auxiliary controller 2019 to each other. The battery 2018 supplies power to blocks of the smart phone 2000 shown in FIG. 18 via feeder lines, which are partially shown as dashed lines in the figure. The auxiliary controller 2019 operates a minimum necessary function of the smart phone 2000, for example, in a sleep mode.

In the smartphone 2000 shown in FIG. 18, the communication unit in the electronic device 300 in the third configuration example of the first embodiment and in the third embodiment described previously with reference to FIG. 3 may be implemented by the wireless communication interface 2012 and optionally the antenna 2016. The functions of the control unit in the electronic device 300 may be implemented by the processor 2001 or the auxiliary controller 2019. For example, the processor 2001 or the auxiliary controller 2019 may implement the functions of the control unit by executing instructions stored in the memory 2002 or the storage apparatus 2003. In addition, the storage unit in the electronic device 300 can be implemented by the memory 2002 or the storage apparatus 2003.

### Second Application Example

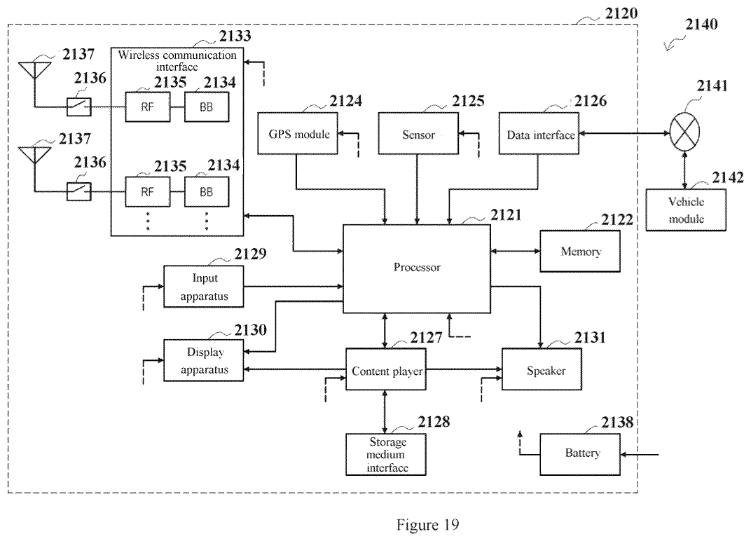

FIG. 19 is a block diagram showing an example of a schematic configuration of a car navigation device 2120 to which the technology according to the present disclosure can be applied. The car navigation device 2120 includes a processor 2121, a memory 2122, a global positioning system (GPS) module 2124, a sensor 2125, a data interface 2126, a content player 2127, a storage medium interface 2128, an input apparatus 2129, a display apparatus 2130, a speaker 2131, a wireless communication interface 2133, one or more antenna switches 2136, one or more antennas 2137, and a battery 2138

The processor 2121 may be, for example, a CPU or a SoC, and control a navigation function and additional function of the vehicle navigation device 2120. The memory 2122 includes RAM and ROM, and stores a program that is executed by the processor 2121, and data.

The GPS module 2124 measures a position (such as latitude, longitude, and altitude) of the car navigation device 2120 by using GPS signals received from a GPS satellite. The sensor 2125 may include a group of sensors such as a gyroscope sensor, a geomagnetic sensor and an air pressure sensor. The data interface 2126 is connected to, for example, an in-vehicle network 2141 via a terminal that is not shown, and acquires data generated by the vehicle (such as vehicle speed data).

The content player 2127 reproduces content stored in a storage medium (such as a CD and a DVD) inserted into the storage medium interface 2128. The input apparatus 2129 includes, for example, a touch sensor configured to detect touch on a screen of the display apparatus 2130, a button, or a switch, and receives an operation or information inputted by a user. The display apparatus 2130 includes a screen such as a LCD or an OLED display, and displays an image of the navigation function or content that is reproduced. The speaker 2131 outputs sounds of the navigation function or the content that is reproduced.

The wireless communication interface 2133 supports any cellular communication scheme (such as LTE and LTE-advanced) and performs wireless communication. The wireless communication interface 2133 may typically include, for example, a BB processor 2134 and an RF circuit 2135. The BB processor 2134 may perform, for example, encoding/decoding, modulating/demodulating, and multiplexing/demultiplexing, and performs various types of signal processing for wireless communication. Meanwhile, the RF circuit 2135 may include for example a mixer, a filter and an amplifier, and transmit and receive a wireless signal via the antenna 2137. The wireless communication interface 2133 may be a chip module having the BB processor 2134 and the RF circuit 2135 integrated thereon. The wireless communication interface 2133 may include multiple BB processors 2134 and multiple RF circuits 2135, as shown in FIG. 19. Although FIG. 19 shows an example in which the wireless communication interface 2133 includes multiple BB processors 2134 and multiple RF circuits 2135, the wireless communication interface 2133 may also include a single BB processor 2134 and a single RF circuit 2135.

Furthermore, in addition to a cellular communication scheme, the wireless communication interface 2133 may support another type of wireless communication scheme such as a short-distance wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches connection destinations of the antennas 2137 among multiple circuits (such as circuits for different wireless communication schemes) included in the wireless communication interface 2133.

Each of the antennas 2137 includes one or more antenna elements (such as multiple antenna elements included in a MIMO antenna) and is used by the wireless communication interface 2133 to transmit and receive a wireless signal. As shown in FIG. 19, the car navigation device 2120 may include multiple antennas 2137. Although FIG. 19 illustrates an example in which the vehicle navigation device 2120 includes multiple antennas 2137, the car navigation device 2120 may also include a single antenna 2137.

In addition, the car navigation device 2120 may include an antenna 2137 for each wireless communication scheme. In this case, the antenna switches 2136 may be omitted from the configuration of the car navigation device 2120.

The battery 2138 supplies power to the blocks of the car navigation device 2120 shown in FIG. 19 via a feeder line, which is partially shown with a dash line in the figure. The battery 2138 accumulates power provided by the vehicle.

In the car navigation device 2120 shown in FIG. 19, the communication unit in the electronic device 300 in the third configuration example of the first embodiment and in the third embodiment described previously with reference to FIG. 3 may be implemented by the wireless communication interface 2133 and optionally the antenna 2137. The functions of the control unit in the electronic device 300 may be implemented by the processor 2121. For example, the processor 2121 may implement the functions of the control unit by executing instructions stored in the memory 2122. In addition, the storage unit in the electronic device 300 can be implemented by the memory 2122.

The technology of the present disclosure may also be implemented as an in-vehicle system (or a vehicle) 2140 including one or more of the automobile navigation device 2120, a vehicle network 2141 and a vehicle module 2142. The vehicle module 2142 generates vehicle data (such as vehicle speed, engine speed, and trouble information), and outputs the generated data to the in-vehicle network 2141.

The technology of the present disclosure may also be implemented as an in-vehicle system (or vehicle) 2140 including one or more blocks of a car navigation device 2120, an in-vehicle network 2141, and a vehicle module 2142. The vehicle module 2142 generates vehicle data (such as vehicle speed, engine speed, and fault information), and outputs the generated data to the in-vehicle network 2141.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

For example, the units shown in dotted boxes in the functional block diagrams shown in the accompanying drawings all indicate that the functional units are optional in the corresponding device, and the various optional functional units can be combined in an appropriate manner to achieve the required functions.

For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included in the technical scope of the present disclosure.

In this specification, the steps described in the flowchart include not only processing executed in time series in the described order but also processing executed in parallel or individually, not necessarily in time series. Furthermore, even in steps processed in time series, it is needless to say that the order can be changed appropriately.

Although the embodiments of the present disclosure are described in detail above in conjunction with the accompanying drawings, it should be understood that the above-described implementation modes are only used to illustrate the present disclosure and do not constitute a limitation to the present disclosure. It will be apparent to those skilled in the art that various modifications and variations can be made to the above-described embodiments without departing from the spirit and scope of the present disclosure. Therefore, the scope of the present disclosure is limited only by the appended claims and their equivalents.

1. An electronic device, comprising:
a processing circuit, configured to
obtain a plurality of pieces of positioning information of a user equipment respectively related to each of a plurality of base stations, wherein the positioning information of the user equipment related to each base station is obtained based on a received signal of a reference signal transmitted between the base station and the user equipment and using a positioning model related to the base station, and wherein the plurality of pieces of positioning information of the user equipment have the same form as each other; and
obtain a positioning result of the user equipment, based on the plurality of pieces of positioning information of the user equipment.

2. The electronic device according to claim 1, wherein each of the plurality of base stations satisfies at least one of the following conditions:
the possibility that a channel between the base station and the user equipment is a line-of-sight path is higher than a predetermined threshold;
a channel quality between the base station and the user equipment is better than a predetermined threshold;
an estimated distance between the base station and the user equipment is less than a predetermined threshold; and
an estimated distance between the base station and a serving base station of the user equipment is less than a predetermined threshold.

3. The electronic device according to claim 1, wherein the positioning model of each base station is pre-acquired through training using a received signal of a reference signal transmitted between the base station and one or more user equipments with known positions as training data.

4. The electronic device according to claim 3, wherein the form of the positioning information includes at least one of: a position of the user equipment; a position of the user equipment and a confidence; and a probability distribution of positions of the user equipment.

5. The electronic device according to claim 1, wherein the processing circuit is further configured to: obtain the positioning result of the user equipment by using a fusion model, based on the plurality of pieces of positioning information of the user equipment.

6. The electronic device according to claim 5, wherein the positioning model of each of the plurality of base stations and the fusion model are pre-acquired through joint training using a received signal of a reference signal transmitted between each of the plurality of base stations and one or more user equipments with known positions as training data.

7. The electronic device according to claim 1, wherein the electronic device is a first base station of the plurality of base stations.

8. The electronic device according to claim 7, wherein the processing circuit is further configured to:
obtain the positioning information of the user equipment related to the first base station, based on the received signal of the reference signal transmitted between the first base station and the user equipment and using the positioning model related to the first base station; and
receive the positioning information of the user equipment related to other base stations of the plurality of base stations except the first base station, from said other base stations.

9. The electronic device according to claim 1, wherein the electronic device is a core network device.

10. The electronic device according to claim 9, wherein the processing circuit is further configured to:
receive the positioning information of the user equipment related to each base station from the plurality of base stations respectively.

11. The electronic device according to claim 7, wherein the reference signal is an uplink reference signal.

12. The electronic device according to claim 11, wherein the uplink reference signal received by at least one of the plurality of base stations from the user equipment satisfies at least one of the following conditions:
the uplink reference signal is an uplink reference signal in an uplink reference signal resource set that is repeatedly sent in the same period; and
the uplink reference signal are uplink reference signals in a plurality of uplink reference signal resource sets that have the same time domain resource and are in the same partial bandwidth and are sent simultaneously.

13. The electronic device according to claim 1, wherein the electronic device is the user equipment.

14. The electronic device according to claim 13, wherein the processing circuit is further configured to: obtain, based on the received signal of the reference signal transmitted between each base station of the plurality of base stations and the user equipment and using the positioning model related to the base station, the positioning information of the user equipment related to the base station.

15. The electronic device according to claim 13, wherein the reference signal is a downlink reference signal.

16. An electronic device, comprising:
a processing circuit configured to
obtain, based on a received signal of a reference signal transmitted between a subject base station and user equipment and using a positioning model related to the subject base station, positioning information of the user equipment related to the subject base station; and
provide the positioning information of the user equipment related to the subject base station to another electronic device, so that said another electronic device can obtain a positioning result of the user equipment based on a plurality of pieces of positioning information of the user equipment respectively related to a plurality of base stations including the subject base station, wherein the plurality of pieces of positioning information of the user equipment have the same form as each other.

17. The electronic device according to claim 16, wherein the electronic device is the subject base station of the plurality of base stations.

18. The electronic device according to claim 16, wherein the reference signal is an uplink reference signal.

19. (canceled)

20. A method for wireless communication, comprising:
obtaining a plurality of pieces of positioning information of a user equipment respectively related to each of a plurality of base stations, wherein the positioning information of the user equipment related to each base station is obtained based on a received signal of a reference signal transmitted between the base station and the user equipment and using a positioning model related to the base station, and wherein the plurality of pieces of positioning information of the user equipment have the same form as each other; and
obtaining a positioning result of the user equipment, based on the plurality of pieces of positioning information of the user equipment.

21.-23. (canceled)

24. The method according to claim 20, wherein each of the plurality of base stations satisfies at least one of the following conditions:
the possibility that a channel between the base station and the user equipment is a line-of-sight path is higher than a predetermined threshold;
a channel quality between the base station and the user equipment is better than a predetermined threshold;
an estimated distance between the base station and the user equipment is less than a predetermined threshold; and
an estimated distance between the base station and a serving base station of the user equipment is less than a predetermined threshold.
